(19) United States
(12) Patent Application Publication
(10) Pub. No.: US 2026/0204706 A1
(43) Pub. Date: Jul. 16, 2026

(54) TOOL BATTERY PACK

(71) Applicant: Lawnix Technology (Nanjing) Co., Ltd., Nanjing (CN)

(72) Inventor: Xiaoke Zou, Nanjing (CN)

(21) Appl. No.: 19/538,726

(22) Filed: Feb. 12, 2026

Related U.S. Application Data
(63) Continuation-in-part of application No. 19/325,957, filed on Sep. 11, 2025.
Application No. 19/325,957 is a continuation of application No. 19/241,883, filed on Jun. 18, 2025, now Pat. No. 12,525,674.

(30) Foreign Application Priority Data
Feb. 28, 2025 (CN) 202520348339.4
Mar. 27, 2025 (CN) 202520561968.5
Apr. 1, 2025 (CN) 202520605792.9
Nov. 21, 2025 (CN) 202511727377.1

(51) Int. Cl. H01M 50/24; H01M 10/42; H01M 50/213; H01M 50/247; H01M 50/519; H01M 50/569

(52) U.S. Cl. CPC H01M 50/24; H01M 10/425; H01M 50/213; H01M 50/247; H01M 50/519; H01M 50/569; H01M 2010/4271

(57) ABSTRACT

Disclosed herein a tool battery pack in the technical field of energy, including: a battery cell assembly and a housing assembly configured to accommodate the battery cell assembly, where the battery cell assembly includes: a unit battery cell; a battery cell holder having a first end and a second end, where the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and a waterproof member disposed at the second end of the battery cell holder, the waterproof member is provided with a first convex face at a position of the exposed hole, and the exposed hole is visible through the waterproof member.

The present application is a continuation-in-part of U.S. patent application Ser. No. 19/325,957, filed on Sep. 11, 2025, which is a continuation of U.S. patent application Ser. No. 19/241,883, filed on Jun. 18, 2025, now U.S. Pat. No. 12,525,674, which claims priority to Chinese Patent Application No. 202520348339.4 filed with the China National Intellectual Property Administration on Feb. 28, 2025 and entitled “BATTERY PACK”, Chinese Patent Application No. 202520561968.5 filed with the China National Intellectual Property Administration on Mar. 27, 2025 and entitled “TOOL BATTERY PACK”, and Chinese Patent Application No. 202520605792.9 filed with the China National Intellectual Property Administration on Apr. 1, 2025 and entitled “TOOL BATTERY PACK”, which are incorporated herein by reference in their entirety. The present application also claims foreign priority to Chinese Patent Application No. 202511727377.1 filed with the China National Intellectual Property Administration on Nov. 21, 2025 and entitled “TOOL BATTERY PACK”, which in turn claims priority to Chinese Patent Application Nos. 202520348339.4, entitled “TOOL BATTERY PACK”, and the entire contents of Chinese Patent Application No. 202511727377.1 are incorporated herein by reference in their entirety.

### TECHNICAL FIELD

Embodiments of the present disclosure relate to the technical field of energy and, in particular, to a tool battery pack.

### BACKGROUND

A battery pack typically includes a plurality of battery cells and complex electrical components, and protecting the battery cells and the electrical connection components from external physical damage is crucial to the structure of the battery pack. In some instances, the waterproofing process for a battery pack involves covering it with a waterproof material and then letting it stand for a period of time before proceeding to subsequent assembly steps. Consequently, the overall production efficiency is limited by the curing time of the waterproof material.

### SUMMARY

According to a first aspect of the present disclosure, a tool battery pack is provided, including: a battery cell assembly; and a housing assembly configured to accommodate the battery cell assembly; where the battery cell assembly includes: a unit battery cell; a battery cell holder having a first end and a second end, where the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and a waterproof member disposed at the second end of the battery cell holder, where the waterproof member has a first end face away from the battery cell holder and a second end face close to the battery cell holder, the waterproof member is provided with a first convex face protruding from the first end face toward the unit battery cell at a position of the exposed hole, and the exposed hole is visible through the waterproof member.

According to a second aspect of the present disclosure, a tool battery pack is provided, including: a battery cell assembly; and a housing assembly configured to accommodate the battery cell assembly; where the battery cell assembly includes: a unit battery cell; a battery cell holder having a first end and a second end, where the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and a waterproof member disposed at the second end of the battery cell holder, where the waterproof member is provided with a directional pressure relief channel within a projection range of the exposed hole, and the waterproof member is transparent at least within the projection range of the exposed hole.

According to a third aspect of the present disclosure, a tool battery pack is provided, including: a battery cell assembly; a housing assembly configured to accommodate the battery cell assembly; and a pressure relief cover disposed inside the housing assembly; where the battery cell assembly includes: a unit battery cell; a battery cell holder having a first end and a second end, where the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and a waterproof member disposed at the second end of the battery cell holder, where the waterproof member is transparent at least within a projection range of the exposed hole, and the waterproof member is disposed between the pressure relief cover and the battery cell holder.

It should be understood that the above general description and the following detailed description are only exemplary and explanatory, and are not intended to limit the present disclosure.

### BRIEF DESCRIPTION OF THE DRAWINGS

FIG. 1 is a top-down perspective view of a battery pack provided in an embodiment of the present disclosure;

FIG. 2 is a bottom-up perspective view of a battery pack provided in an embodiment of the present disclosure;

FIG. 3 is an internal structural view of a battery pack provided in an embodiment of the present disclosure;

FIG. 4 is an exploded internal structural view of a battery pack provided in an embodiment of the present disclosure;

FIG. 5 is a sectional view of a unit battery cell provided in an embodiment of the present disclosure;

FIG. 6 is a perspective view of a first end face of a waterproof member of a battery pack provided in an embodiment of the present disclosure;

FIG. 7 is a perspective view of a second end face of a waterproof member of a battery pack provided in an embodiment of the present disclosure;

FIG. 8 is a partially enlarged sectional view of a position A of the waterproof member in FIG. 6;

FIG. 9 shows an assembly relationship between a local waterproof member, a waterproof layer, a battery cell holder, and a unit battery cell provided in an embodiment of the present disclosure;

FIG. 10 is a partial sectional view of an internal structure of a battery pack provided in an embodiment of the present disclosure, with a waterproof member and a waterproof layer hidden;

FIG. 11 is a partial perspective view of an electrode holder provided in an embodiment of the present disclosure;

FIG. 12 is a front view of an electrode holder provided in an embodiment of the present disclosure;

FIG. 13 is an internal structural view of a battery pack provided in an embodiment of the present disclosure;

FIG. 14 is a perspective view of a connecting member provided in an embodiment of the present disclosure;

FIG. 15 is a front view of a first welding base provided in an embodiment of the present disclosure;

FIG. 16 is a front view of a second welding base provided in an embodiment of the present disclosure;

FIG. 17 is a partial sectional view of a battery cell assembly provided in an embodiment of the present disclosure;

FIG. 18 is a sectional view of a unit battery cell provided in an embodiment of the present disclosure;

FIG. 19 is a schematic structural view of a negative end face according to an embodiment of the present disclosure;

FIG. 20 is a partial sectional view of a first implementation manner of a waterproof member provided in an embodiment of the present disclosure;

FIG. 21 is a partial sectional view of a second implementation manner of a waterproof member provided in an embodiment of the present disclosure;

FIG. 22 is a partial sectional view of a third implementation manner of a waterproof member provided in an embodiment of the present disclosure;

FIG. 23 is an internal structural view of a battery pack provided in an embodiment of the present disclosure;

FIG. 24 is a partial sectional view of a unit battery cell provided in an embodiment of the present disclosure;

FIG. 25 is a schematic structural view of a first implementation manner of a waterproof member provided in an embodiment of the present disclosure;

FIG. 26 is a schematic structural view of a second implementation manner of a waterproof member provided in an embodiment of the present disclosure;

FIG. 27 is a schematic structural view of a third implementation manner of a waterproof member provided in an embodiment of the present disclosure;

FIG. 28 is a schematic structural view of a fourth implementation manner of a waterproof member provided in an embodiment of the present disclosure;

FIG. 29 is a sectional view along an A-A direction in FIG. 23;

FIG. 30 is a temperature variation data graph of a 60V battery cell and a battery cell end face under a 30 A discharging mode provided in an embodiment of the present disclosure;

FIG. 31 is a temperature variation data graph of a unit battery cell undergoing thermal runaway and an adjacent battery cell of a tool battery pack provided in an embodiment of the present disclosure; and

FIG. 32 is a schematic structural view of a fifth implementation manner of a waterproof member provided in an embodiment of the present disclosure.

### DETAILED DESCRIPTION OF THE EMBODIMENTS

To make the objectives, technical solutions, and advantages of the embodiments of the present disclosure clearer, the embodiments of the present disclosure will be described below in detail with reference to the accompanying drawings. However, it may be understood by a person of ordinary skill in the art that in the embodiments of the present disclosure, many technical details are proposed for readers to better understand the present disclosure. Even without these technical details and various changes and modifications based on the following embodiments, the technical solutions claimed to be protected by the present disclosure may also be implemented. The following embodiments are divided for ease of description, and shall not be construed as any limitation on the implementation manners of the present disclosure. The embodiments may be combined with each other and cross-referenced on the premise of no contradiction.

As can be seen from the background, tool battery packs in the prior art are typically composed of 1-parallel or 2-parallel battery cell assemblies. Unit battery cells in these battery packs are arranged in groups, and conductive electrodes are usually connected to battery cell end faces to establish connectivity with a control board. To prevent short circuiting due to electrical conduction between the unit battery cells, the battery cell end faces should be covered with a waterproof material, ensuring relative isolation between the unit battery cells. In this case, to achieve waterproofing, the assembly process proceeds to subsequent steps only after the waterproof material is applied and allowed to stand for a period of time. Consequently, the overall production efficiency is limited by the curing time of the waterproof material, becoming a rigid bottleneck in the entire battery pack production process. Meanwhile, tools have relatively low power and charging/discharging requirements, resulting in a very low probability of thermal runaway in the battery packs. However, as tool power continues to increase, the higher charging/discharging rates lead to larger local temperature gradients, significantly raising the risk of thermal runaway. A battery cell undergoing thermal runaway will experience irreversible overheating, with its end face temperature rising sharply, typically triggering high-pressure and high-temperature flame ejection at the battery cell end face. If the battery cell undergoing thermal runaway is not contained, the surface temperature of an adjacent battery cell will be affected by thermal propagation therefrom, causing the adjacent battery cell to also undergo thermal runaway, consequently leading to cascading thermal runaway across the battery pack.

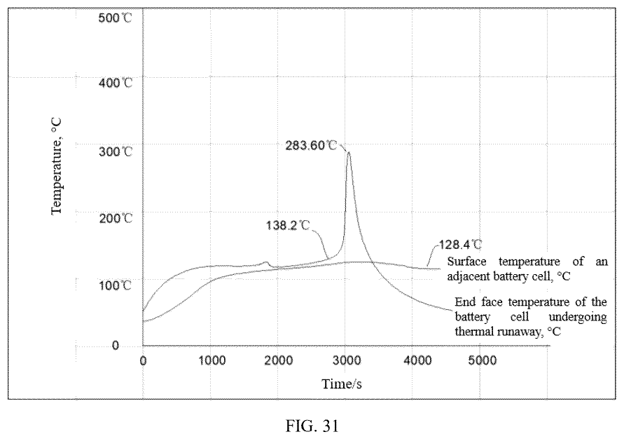

For example, during 30 A discharging of a 60V unit battery cell 21, as shown in FIG. 31, the temperature rise of the battery cell end face reaches about 60° C. As current intensity increases, the temperature rise of the battery cell end face also escalates. During charging/discharging, if the temperature of the battery cell end face continues rising and reaches 100° C., the surface temperature of an adjacent battery cell will progressively rise following the temperature rise of the battery cell undergoing thermal runaway. When the battery cell undergoing thermal runaway reaches 283.6° C., it will experience irreversible overheating, with its end face temperature rising sharply, typically triggering high-pressure and high-temperature flame ejection at a positive end face area. If the battery cell undergoing thermal runaway is not contained, the surface temperature of the adjacent battery cell will be affected by thermal propagation therefrom, causing the adjacent battery cell to also undergo thermal runaway, consequently leading to cascading thermal runaway across the battery pack.

For example, in some waterproofing solutions, sealing is primarily achieved through a planar, overlay-type waterproof layer (such as applying a layer of waterproof adhesive to the end face of the battery cell holder). However, this structure cannot specifically solve the sealing problem of the gap between the unit battery cell and the battery cell holder, presenting an obviously weak waterproofing area. Moreover, the waterproof layer can only cover the end face of the unit battery cell, while the annular clearance between the circumference of the unit battery cell and the inner wall of the receiving slot in the battery cell holder remains unfilled. Moisture can easily penetrate into the interior of the battery cell or the core area of the battery pack (such as the circuit board) through this clearance, leading to waterproofing failure. Furthermore, the waterproof layer relies solely on its own fluidity for natural diffusion, making it difficult to actively fill micro-gaps. It is also prone to forming local sealing defects due to issues like uneven disclosure or bubbles, resulting in insufficient waterproofing reliability. Additionally, some tool battery packs are not designed with directional pressure relief structures for unit battery cells after assembly to address thermal runaway. This can trigger thermal propagation (i.e., adjacent battery cells undergoing thermal runaway successively), thereby expanding the fault scope. On the other hand, the pressure relief direction of a battery cell undergoing thermal runaway cannot be predetermined. This may cause high-temperature gas or flames to directly impact components surrounding the battery pack (such as circuit boards or connectors) or be ejected outward, endangering users, due to the lack of a safe and controllable pressure relief path.

The aforementioned defects and their causes have been discovered through research on the internal temperature of overheated battery cells and battery cells undergoing thermal runaway in tool battery packs, as well as the overall heat transfer within the battery packs. To solve the above technical problems, the present disclosure provides a tool battery pack, which, by ingeniously arranging a waterproof member and rationally designing the battery pack structure and materials, addresses issues such as the size constraints of tool battery packs and low production efficiency of battery packs, and simultaneously provides rapid pressure relief for battery cells undergoing thermal runaway to reduce secondary thermal runaway triggers, thereby achieving a solution characterized by lightweight design, high efficiency, and safe isolation. As an implementation manner, an embodiment of the present disclosure will be described below in more detail with reference to the accompanying drawings:

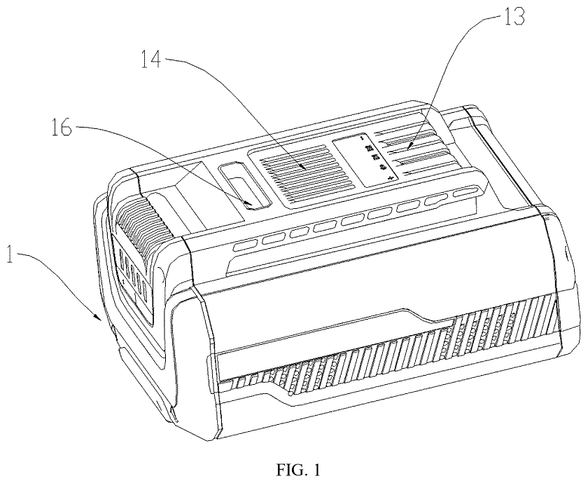

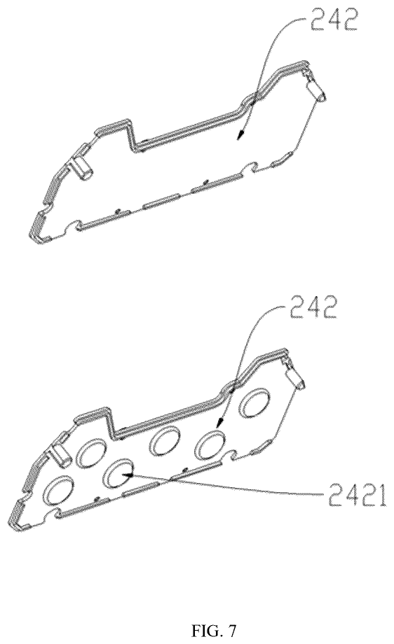

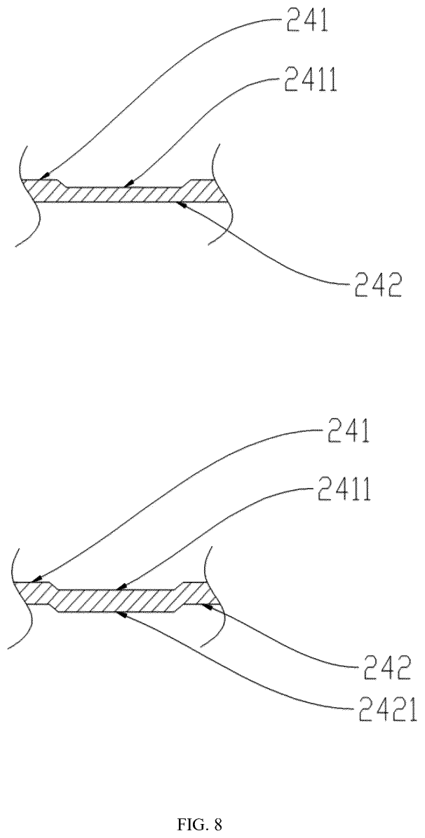

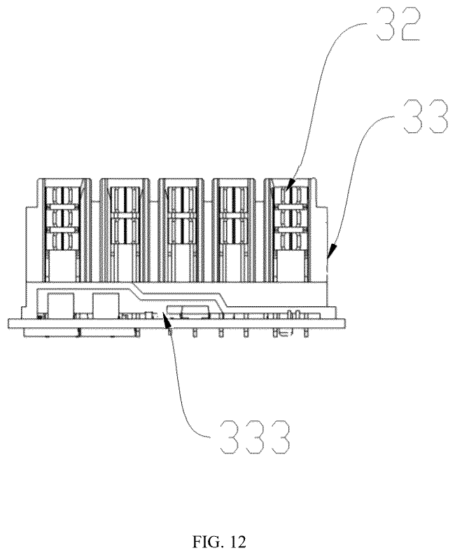

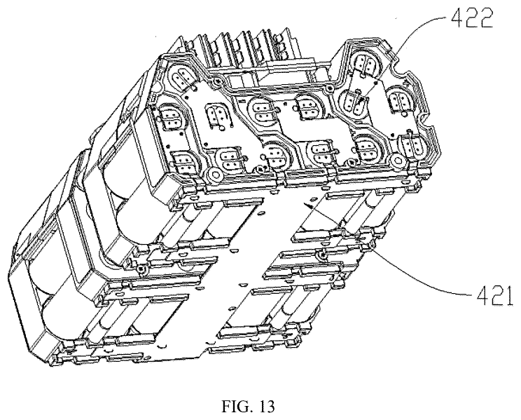

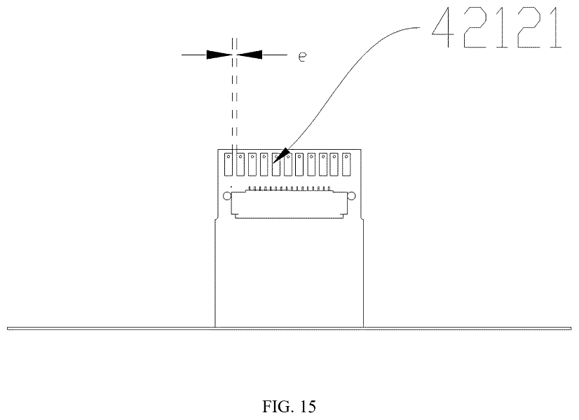

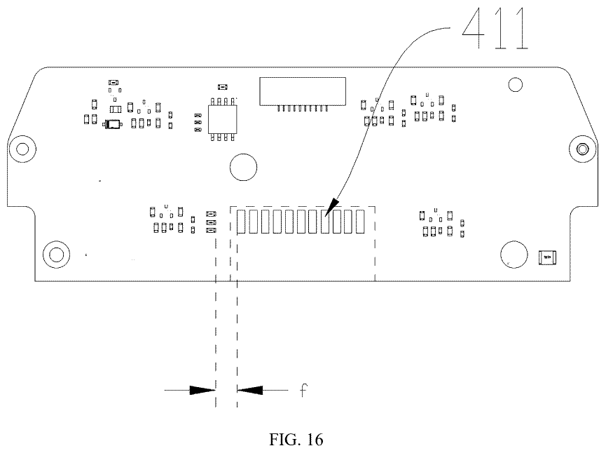

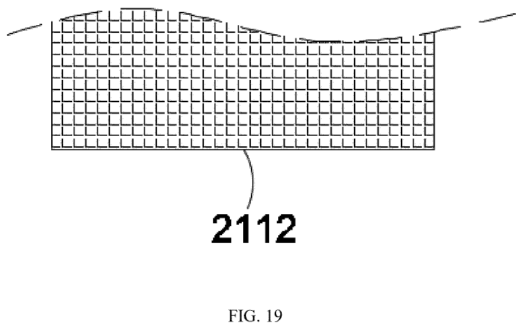

referring to FIGS. 1 to 31, a tool battery pack is provided, including a housing assembly 1 and a battery cell assembly 2, where the housing assembly 1 is configured to accommodate the battery cell assembly 2.

Referring to FIGS. 1 to 3, as a housing portion of the tool battery pack, the housing assembly 1 includes a first heat dissipation vent 11, a holder mounting base (not shown), an opening 13, and a second heat dissipation vent 14, where the housing assembly 1 is configured to accommodate the battery cell assembly 2, an electrode holder 3, and a control device 4; the opening 13 is disposed at a position on the housing assembly 1 corresponding to the electrode holder 3 to allow an electrode to pass through and connect with the electrode holder 3; and a heat dissipation vent is disposed on a side of the battery pack having the opening 13. This heat dissipation vent may be a first heat dissipation vent 11 or a second heat dissipation vent 14. Taking the heat dissipation vent disposed on the side with the opening 13 as the second heat dissipation vent 14, the first heat dissipation vent 11 and the second heat dissipation vent 14 are disposed opposite each other on a surface of the housing assembly 1 to form a linear airflow channel where one heat dissipation vent serves as an air inlet and the other heat dissipation vent as an air outlet. For example, the first heat dissipation vent 11 may be configured as the air inlet and the second heat dissipation vent 14 as the air outlet, or the first heat dissipation vent 11 may be configured as the air outlet and the second heat dissipation vent 14 as the air inlet. By configuring the first heat dissipation vent 11 and the second heat dissipation vent 14 to form a linear airflow channel, an airflow can pass through the battery pack more efficiently, ensuring the internal temperature of the battery pack is always maintained within a safe range, significantly improving heat dissipation efficiency and reducing the risk of battery cell explosion due to overheating. The holder mounting base (not shown) is disposed on at least one inner surface of the housing assembly 1 to secure the battery cell assembly 2, thereby reducing movement of the battery cell holder 22 within the housing assembly 1. In an implementation manner of the present disclosure, taking the first heat dissipation vent 11 as the air inlet and the second heat dissipation vent 14 as the air outlet as an example, a total area of the first heat dissipation vent 11 may be further designed to be greater than a total area of the second heat dissipation vent 14, thereby allowing an airflow entering the housing assembly 1 through the first heat dissipation vent 11 to be exhausted from the second heat dissipation vent 14. The larger area of the first heat dissipation vent 11 facilitates the intake of more cool air, enabling the cool air to fully contact the battery cell assembly 2.

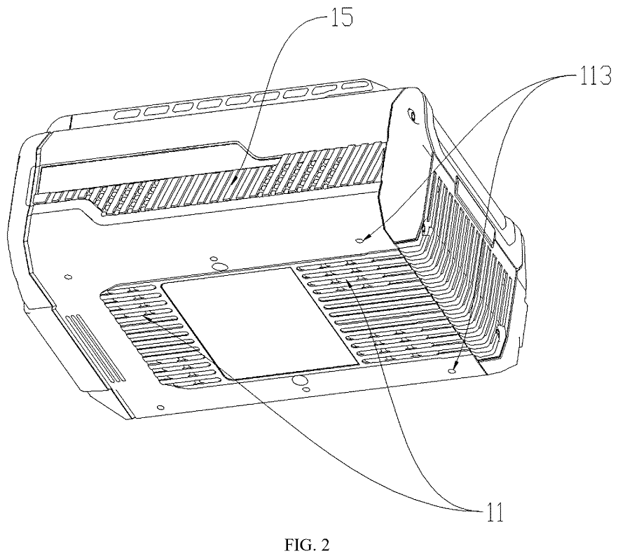

Referring to FIG. 2, in some implementation manners, the housing assembly 1 may further be designed to have a third heat dissipation vent 15 located on any side of the housing assembly 1 other than those provided with the first heat dissipation vent 11 and the second heat dissipation vent 14, thereby introducing an airflow from the side into the interior of the housing assembly, and the airflow through the third heat dissipation vent 15 converges with that through the first heat dissipation vent 11 to form a combined airflow that is exhausted through the second heat dissipation vent 14. By providing the third heat dissipation vent 15, it enables multi-directional airflow intake into the battery pack, promotes more uniform heat distribution across the battery cell assembly 2, and reduces local overheating. The convergence of internal airflows ensures more comprehensive and efficient airflow distribution across the surface of the battery cell, maintaining overall thermal equilibrium while further enhancing the battery pack's heat dissipation capability. This design not only enhances air circulation and improves internal heat exchange efficiency but also ensures reliable heat dissipation. Even if one heat dissipation vent is partially blocked by external factors, the battery pack can still achieve sufficient heat dissipation through the other air inlet. Such a multi-inlet/single-outlet airflow configuration facilitates faster surface temperature reduction of the battery cell.

Referring to FIG. 2, in some implementation manners, the housing assembly 1 further includes third heat dissipation vents 15 located on any two opposite sides of the housing assembly 1 other than those provided with the first heat dissipation vent 11 and the second heat dissipation vent 14, thereby introducing airflows from the opposite sides into the interior of the battery pack, and the airflows through the third heat dissipation vents 15 converge with that through the first heat dissipation vent 11 to form a combined airflow that is exhausted through the second heat dissipation vent 14. By providing the third heat dissipation vents 15, it enables multi-directional airflow intake into the battery pack, promotes more uniform heat distribution across the battery cell assembly 2, and reduces local overheating. The convergence of internal airflows ensures more comprehensive and efficient airflow distribution across the surface of the battery cell, maintaining overall thermal equilibrium while further enhancing the battery pack's heat dissipation capability. This design not only enhances air circulation and improves internal heat exchange efficiency but also ensures reliable heat dissipation. Even if one heat dissipation vent is partially blocked by external factors, the battery pack can still achieve sufficient heat dissipation through the other air inlets. Such a multi-inlet/single-outlet airflow configuration facilitates faster surface temperature reduction of the battery cell.

In some implementation manners, a total area of the third heat dissipation vent 15 is less than or equal to that of the second heat dissipation vent 14, thereby solving the problem of local overheating caused by a single airflow direction. Sufficient air intake in the lateral direction or in other directions ensures uniform heat dissipation across all parts of the battery cell while preventing performance degradation or safety risks caused by local overheating. The meticulous vent configuration allows better control of temperature gradients across different areas of the device. The multi-inlet/single-outlet configuration ensures that even if one heat dissipation vent malfunctions due to partial blockage or other problems, sufficient airflow and heat dissipation effect can be provided by the remaining heat dissipation vents, thereby guaranteeing continuous operation and reliability of the system.

In some implementation manners, a total area of the third heat dissipation vent 15 is larger than that of the second heat dissipation vent 14, thereby solving the problem of local overheating caused by a single airflow direction. Sufficient air intake in the lateral direction or in other directions ensures uniform heat dissipation across all parts of the battery cell while preventing performance degradation or safety risks caused by local overheating. The meticulous vent configuration allows better control of temperature gradients across different areas of the device. The multi-inlet/single-outlet configuration ensures that even if one heat dissipation vent malfunctions due to partial blockage or other problems, sufficient airflow and heat dissipation effect can be provided by the remaining heat dissipation vents, thereby guaranteeing continuous operation and reliability of the system.

Referring to FIG. 1, in some implementation manners, the second heat dissipation vent 14 is arranged at a central area on the side of the housing assembly 1 that is provided with the opening 13 and opposite to the first heat dissipation vent 11, enabling more uniform airflow distribution across the surface of the battery cell assembly 2. The resulting center-to-periphery airflow pattern mitigates local overheating while maintaining temperature uniformity inside the battery pack.

Referring to FIG. 1, in some implementation manners, the second heat dissipation vent 14 is arranged at a central area on the side of the housing assembly 1 that is provided with the opening 13 and opposite to the first heat dissipation vent 11, and is adjacent to the opening 13, enabling more uniform airflow distribution across the surface of the battery cell assembly 2. The resulting center-to-periphery airflow pattern mitigates local overheating while maintaining temperature uniformity inside the battery pack.

Referring to FIG. 1, in some implementation manners, the housing assembly 1 is provided with a locking slot 16 for locking the tool battery pack to mitigate displacement of the battery pack. The second heat dissipation vent 14 is arranged at a central area on the side of the housing assembly 1 that is provided with the opening 13 and opposite to the first heat dissipation vent 11, and is located between the second heat dissipation vent 14 and the locking slot 16, enabling more uniform airflow distribution across the surface of the battery cell assembly 2. The resulting center-to-periphery airflow pattern mitigates local overheating while maintaining temperature uniformity inside the battery pack.

In some implementation manners, the housing assembly 1 has a 2-part split configuration and is designed as a recessed housing with an opening on the top or any side, where an end cover is connected to the housing via the side where the opening 13 is located; or the housing assembly 1 has a 3-part split configuration and is designed as a through-type integrally molded housing with openings 13 on opposite sides, where an end cover is connected to the housing via the openings 13; or the housing assembly 1 has a 4-part split configuration and is designed as a through-type split housing with openings on opposite sides, where the housing allows for top-bottom closing and an end cover is connected to the housing via the openings 13. The assembly form of the housing assembly 1 is not specifically limited herein.

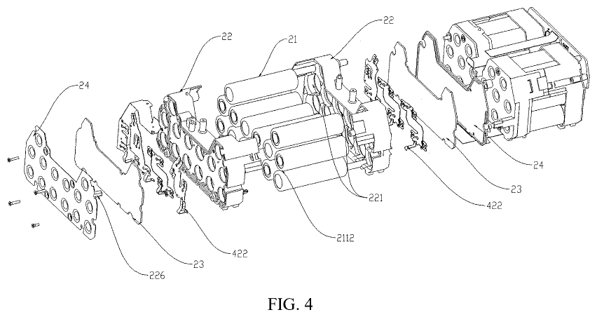

Referring to FIG. 4, in some implementation manners, the battery cell assembly 2 includes a unit battery cell 21, a battery cell holder 22, a waterproof layer 23, and a waterproof member 24, where the unit battery cell 21 is accommodated in the battery cell holder 22, the waterproof layer 23 is located between the unit battery cell 21 and the waterproof member 24, and the battery cell holder 22 supports the unit battery cell 21, the waterproof layer 23, the waterproof member 24, and an exposed hole 222.

In some embodiments, the waterproof member 24 is not a regularly shaped component. For example, the waterproof member 24 includes a planar portion and at least one inclined portion. For instance, the planar portion may be a main body portion of the waterproof member, and the inclined portion may be a connecting portion that achieves a disclosed connection. For instance, the waterproof member includes a main body portion 243, a first connecting portion 244, and a second connecting portion 245.

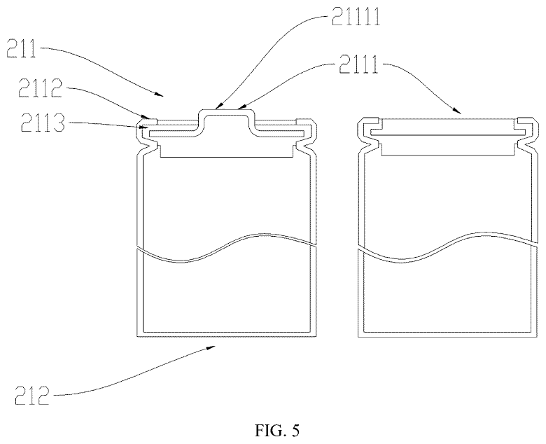

Referring to FIG. 5, in some implementation manners, the unit battery cell 21 is a cylindrical battery cell having a first battery cell end face 211 and a second battery cell end face 212. The first battery cell end face 211 and the second battery cell end face 212 are end faces of different polarities. For example, the first battery cell end face 211 is a positive end face 2111, and the second battery cell end face 212 is a negative end face. On this basis, the positive end face 2111 is a planar end face. When the positive end face 2111 is a planar end face and the unit battery cell 21 experiences thermal runaway, the high-temperature and high-pressure gas from the interior of the battery cell breaches the positive end face 2111, impacting the second face of the first connecting portion and/or the first face of the second connecting portion of the waterproof member 24. Particularly, the gas impacts a first groove 24113 and/or a second groove 24114, thereby preferentially generating a pressure relief opening at a predetermined position. This cooperates with the recessed space and the directional pressure relief channel of the waterproof member 24 to guide the airflow out. On the one hand, this reduces the risk of random bursting at the sidewall of the battery cell casing or other unintended positions, lowering the risk of impact damage to adjacent unit battery cells 21, conductive components, and the housing assembly; on the other hand, it allows for spatially controllable constraints on the pressure relief direction and location, contributing to improved overall safety and predictability of the tool battery pack under thermal runaway conditions of the battery cell.

In some embodiments, the first connecting portion is arranged obliquely with the main body portion as a reference, and an inclination angle B of the first connecting portion relative to the main body portion is 30° to 60°.

Referring to FIG. 5, in some implementation manners, the positive end face 2111 is provided with a cap end face 21111, where the cap end face 21111 protrudes outward from the positive end face 2111.

The unit battery cell 21 with an outwardly protruding cap has a built-in safety valve, which typically contains a preset metal diaphragm. When the internal pressure of the battery cell reaches a specific threshold, the cap actively and directionally ruptures to perform initial pressure relief. When the first connecting portion and/or the second connecting portion (the first convex face and/or the second convex face), particularly the first groove 24113 and/or the second groove 24114, is directly aligned with the cap end face 21111, it cooperates with the battery cell's safety valve in a relay manner, achieving a two-stage, progressively cascading pressure relief. That is, the unit battery cell 21 itself has a primary pressure relief structure (the safety valve), while the waterproof member provides a secondary pressure relief structure with the first groove and/or the second groove, and a tertiary pressure relief structure with the first connecting portion and/or the second connecting portion.

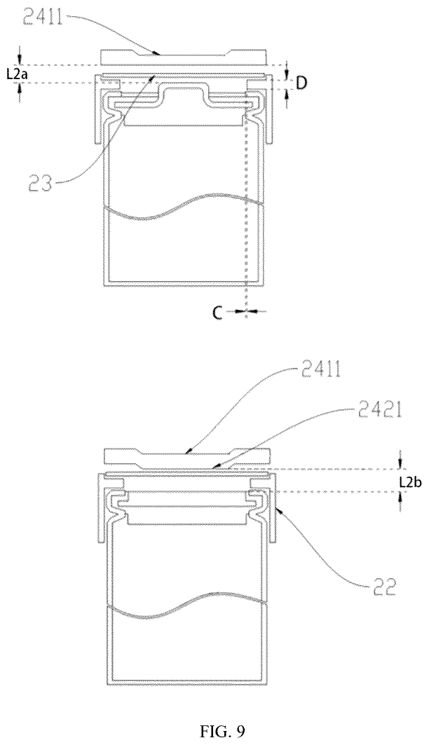

Referring to FIGS. 5 and 9, in some implementation manners, the first battery cell end face 211 and the second battery cell end face 212 are two battery cell end faces with opposite polarities. That is to say, when the first battery cell end face 211 is a positive end face 2111, the second battery cell end face 212 is a negative end face. At the first battery cell end face 211, taking an edge of the negative end face 2112 close to a central axis of the unit battery cell 21 as a first edge, the exposed hole 222 exposes the first edge, and a projected distance C between the first edge and an inner edge of the exposed hole 222 is greater than or equal to 0.1 mm. By setting a distance between the exposed hole 222 and the first edge, it not only structurally enhances the electrical insulation and isolation but also allows the waterproof layer 23 to cover the negative end face 2112. The waterproof layer 23 thus serves as an additional barrier, preventing moisture ingress into the interior of the battery cell. Simultaneously, the waterproof layer 23 covers the negative end face 2112 and the exposed hole 222, ensuring that moisture does not seep through the assembly gap of the receiving slot 221 into the battery cell end face along the length direction of the battery cell to contact the positive end face 2111 and the negative end face 2112, thereby reducing potential short-circuit situations.

Referring to FIG. 4, in some implementation manners, the battery cell holder 22 is provided with a receiving slot 221, an exposed hole 222, a first end 223, and a second end 224, where the receiving slot 221 is arranged at the first end 223 of the battery cell holder 22 to receive the unit battery cell 21, with one end of the receiving slot 221 having an opening for receiving the unit battery cell 21 and the other end of the receiving slot 221 having the exposed hole 222 penetrating through the battery cell holder 22; an inner area of the exposed hole 222 is smaller than a cross-sectional area of the receiving slot 221 parallel to the exposed hole 222; an area of the exposed hole 222 is smaller than a maximum area of the first battery cell end face 211 extending into the receiving slot 221; a shape of the exposed hole 222 includes but is not limited to circular, oval, and square shapes; and the battery cell holder 22 is firmly fixed to the holder mounting base in the housing assembly 1 by means of, but not limited to, welding or screw connection to provide additional structural support and anti-vibration protection.

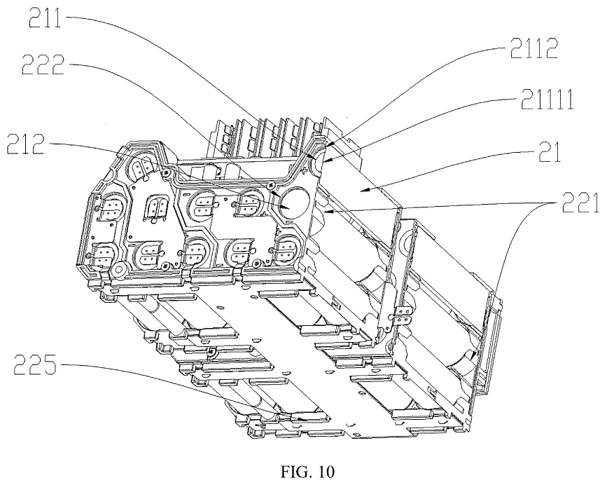

Referring to FIG. 10, in some implementation manners, the battery cell holder 22 is provided with a limiting portion 225 that engages with the holder mounting base, and the limiting portion 225 includes a locking member 2251, which may take various forms, including but not limited to a screw hole tightened with a screw, a first mortise-tenon structure engaged with a second mortise-tenon structure on the housing assembly 1, welding the limiting portion 225 onto the housing assembly 1, or adhesive bonding, thereby preventing the battery cell holder 22 from displacement within the housing assembly 1.

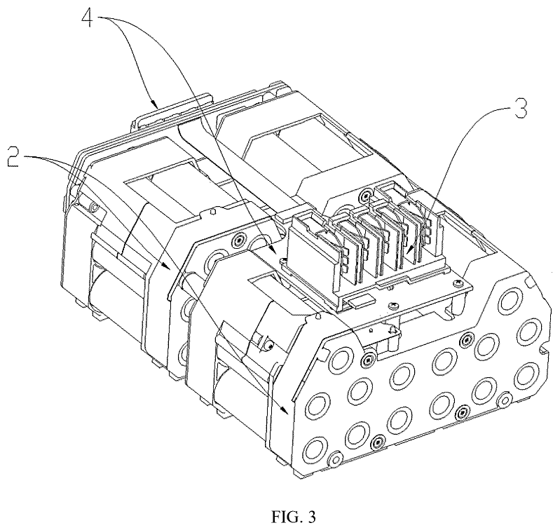

Referring to FIG. 9, in some implementation manners, an inner height D of the exposed hole 222 is more than or equal to 0.5 mm and less than or equal to 2.5 mm. By setting the inner height D of the exposed hole 222 to be more than or equal to 0.5 mm, it provides effective support strength for the unit battery cell 21, thereby preventing positional displacement of the unit battery cell 21 caused by vibration or other external forces during normal use and enhancing the overall mechanical stability and safety of the tool battery pack. Additionally, keeping the inner height less than or equal to 2.5 mm helps reinforce the support strength while reducing unnecessary material usage, thereby optimizing the weight of the battery pack and further improving energy efficiency and endurance. This height range also ensures efficient utilization of the internal space within the battery cell. While ensuring strong support, the well-designed inner height of the exposed hole reduces unnecessary occupation of the battery pack's effective space, allowing the battery pack to maximize capacitance and energy density within a limited space. Referring to FIGS. 3 to 5, the waterproof layer 23 is arranged at the second end 224 of the battery cell holder 22 through either a potting process or a vacuum deposition process, and covers the first and second battery cell end faces 211, 212 of the unit battery cell 21, thereby reducing short-circuit risks caused by contact between the first and second battery cell end faces 211, 212 and external moisture.

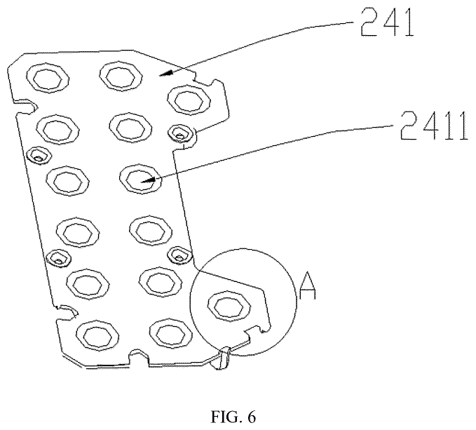

Referring to FIGS. 6 to 10, in some implementation manners, the waterproof member 24 is arranged at the second end 224 of the battery cell holder 22 and has a first end face 241 away from the battery cell holder 22 and a second end face 242 close to the battery cell holder 22.

In some implementation manners, the waterproof member 24 has a first convex face 2411 at a position of the exposed hole 222. By configuring the waterproof member 24 to be weak at the exposed hole 222, during abnormal overheating conditions of the battery cell, high-pressure and high-temperature flame ejection typically occurs at the first battery cell end face 211. In such cases, an abnormal unit battery cell 21 can rapidly break through the weak area of the waterproof member 24, thereby providing a safe pressure relief mechanism that reduces impact on adjacent unit battery cells 21 or battery cell assemblies 2 and avoids cascading thermal runaway events. Here, “weak area” refers to an area where, compared to other areas of the waterproof member 24, the strength and stiffness of the local area are reduced by decreasing the wall thickness and/or providing structures such as grooves or recesses. This ensures that under the action of the high-temperature and high-pressure gas or external force generated during thermal runaway of the unit battery cell 21, the weak area is capable of preferentially yielding or rupturing, thereby forming a pressure relief opening at a predetermined position.

Compared to conventional battery pack waterproofing processes, which require applying a waterproof layer and then letting it stand for a period of time before proceeding to subsequent assembly steps, thereby limiting overall production efficiency due to the curing time of the waterproof layer, the present disclosure overcomes the aforementioned defect by adding a waterproof member with the first convex face 2411. First, after the waterproof layer 23 is applied over the battery cell holder 22, the waterproof member 24 can immediately cover and press against the waterproof layer 23 without waiting for it to dry. By using the waterproof member 24 to cover and press against the waterproof layer 23, an assembly isolation is formed between the waterproof layer 23 and other components of the battery pack, isolating the unit battery cell 21 from the external environment. This eliminates the waiting time for the waterproof layer 23 to cure and does not affect the subsequent assembly of other components of the battery pack (such as circuit boards and connectors), greatly improving the production takt time, reducing the waiting time for the waterproof layer 23 to cure, and enhancing production flexibility and responsiveness. Secondly, the first convex face 2411 directly and precisely applies a directional squeezing force to the end face of the unit battery cell 21 covered by the waterproof layer 23, enabling the waterproof layer 23 to flow and fill along the gap between the circumference of the unit battery cell 21 and the inner wall of the receiving slot in the battery cell holder 22. Consequently, the waterproof layer 23 can wrap the battery cell end face while also effectively wrapping the side areas near the battery cell end face, forming multi-directional waterproof sealing for both the battery cell end face and the battery cell holder 22 area, significantly improving the waterproofing effect. Finally, the first convex face 2411 is arranged relative to the exposed hole 222, and the material at the convex face is stretched and thinned, forming a structurally weak area and a natural stress concentration area. Since the first convex face 2411 is close to the battery cell end face, when the unit battery cell 21 experiences thermal runaway, the first convex face 2411 is subjected to impact first and rapidly and ruptures upon impact, rapidly relieving pressure within the internal space of the battery cell holder 22 and reducing the effect of thermal diffusion. This significantly suppresses the risk of energy generated by thermal runaway spreading to adjacent unit battery cells 21 or other areas of the battery pack (thermal propagation), establishes a safe pressure relief mechanism for the tool battery pack, and substantially enhances the overall safety performance of the tool battery pack.

The waterproof member 24 is integrally formed, injection molded, and has a hardness greater than that of the material of the waterproof layer under normal temperature conditions.

Referring to FIG. 9, at least a portion of the waterproof layer 23 is arranged between the second end face 242 and the battery cell holder 22. By adding the waterproof member 24, subsequent assembly steps can proceed immediately after the waterproof layer 23 covers the battery cell holder 22, eliminating the need to wait for the waterproof layer 23 to dry, which significantly enhances production line efficiency, reduces waiting time, and improves production flexibility and responsiveness.

Compared to conventional waterproofing processes, which typically involve applying a waterproof material and then letting it stand for a period of time before proceeding to subsequent assembly steps, thereby limiting overall production efficiency due to the curing time of the waterproof material, the present disclosure, on the one hand, overcomes the aforementioned defect by providing the waterproof member 24 with the first convex face 2411. This allows subsequent assembly work to proceed after the waterproof layer 23 covers the battery cell holder 22 without waiting for the waterproof layer 23 to dry, which significantly improves production line efficiency, reduces waiting time, and enhances production flexibility and responsiveness. On the other hand, the first convex face 2411 is arranged relative to the exposed hole 222, and the position of the first convex face 2411 corresponding to the exposed hole 222 is subjected to impact first when the unit battery cell 21 experiences thermal runaway. The first convex face 2411 ruptures upon impact, rapidly relieving pressure within the internal space of the battery cell holder 22 and reducing the effect of thermal diffusion. This achieves a safe pressure relief mechanism for the tool battery pack, further improving safety performance of the tool battery pack and reducing issues of secondary thermal runaway in the unit battery cells 21.

Meanwhile, the second end face 242 is planar. As shown in FIG. 6, the waterproof member 24 has a first convex face 2411 at a position of the exposed hole 222. By configuring the waterproof member 24 to be weak at the exposed hole 222, during abnormal overheating conditions of the battery cell, high-pressure and high-temperature flame ejection typically occurs at the first battery cell end face 211. In such cases, an abnormal unit battery cell 21 can rapidly break through the weak area of the waterproof member 24, thereby providing a safe pressure relief mechanism that reduces impact on adjacent unit battery cells 21 or battery cell assemblies 2 and avoids cascading thermal runaway events.

In some implementation manners, the exposed hole 222 is visible through the waterproof member 24. For example, the exposed hole 222 is located on one side of the waterproof member 24. In this case, the exposed hole 222 being visible through the waterproof member 24 can be understood as the exposed hole 222 being observable from the other side of the waterproof member 24.

In some implementation manners, the waterproof member 24 is at least transparent within a projection range of the exposed hole 222 thereon. That is, the waterproof member 24 is locally transparent. This transparency includes: full transparency and/or translucency. The translucency is lower than the full transparency. For example, the waterproof member 24 may be entirely fully transparent or translucent; or, the waterproof member 24 may be fully transparent or translucent only within the projection range of the exposed hole 222 thereon.

In some implementation manners, the waterproof member 24 is made of a first material having a visible light transmittance of 70% or greater.

In some implementation manners, the battery cell holder 22 is made of a second material. For example, the second material is different from the first material, meaning the materials of the waterproof member 24 and the battery cell holder 22 are different. Also for example, visual effects of the first material and the second material are different, achieving a visual distinction between the waterproof member 24 and the battery cell holder 22. This difference in visual effect may be manifested in at least one of the following: the colors of the first material and the second material are different, the transmittances of the first material and the second material are different, or the reflectances of the first material and the second material are different. For example, the visible light transmittance of the first material is greater than that of the battery cell holder 22. Also for example, the transparency of the waterproof member 24 is higher than that of the battery cell holder 22, enabling the waterproof layer 23 inside the battery cell holder 22 to be viewed through the transparent waterproof member 24. This facilitates direct visual inspection of the actual condition of the waterproof layer 23 inside the battery cell holder 22.

In some implementation manners, the battery cell assembly 2 further includes a waterproof layer 23 disposed between the waterproof member 24 and the battery cell holder 22 and covering the exposed hole 222. Since the waterproof member 24 is locally transparent within the projection range of the exposed hole 222, the waterproof member 24 can also be designed to be fully transparent. This allows for direct visual inspection of the actual condition of the waterproof layer 23 inside the battery cell holder 22 through the waterproof member 24. When the waterproof member 24 is locally transparent within the projection range of the exposed hole 222, the connecting portion between the waterproof member 24 and the battery cell holder 22 is non-transparent. The waterproof member 24 being locally transparent within the projection range of the exposed hole 222 means that the transparent portion of the waterproof member 24 is at least partially located inside the outer contour of the exposed hole 222, allowing at least part of the second end 224 of the unit battery cell 21 to be seen through the transparent portion and the exposed hole 222. For example, the waterproof layer 23 is applied over the exposed hole 222, so the waterproof layer 23 is visible through the waterproof member 24. In this case, the disclosure condition of the waterproof layer 23 and the exposed hole 222 can be directly observed. After the waterproof layer is applied, the outer contour of the exposed hole 222 may also be faintly revealed through the waterproof layer 23, facilitating observation from the outside of the waterproof member 24 as well.

In some cases, comparatively speaking, a fully transparent design of the waterproof member 24 can cover the entire area between the second end of the battery cell holder and the waterproof member. On the one hand, operators can inspect not only the peripheral area of the exposed hole 222 but also other areas beyond the peripheral area, such as the edges of the second end of the battery cell holder, potential issues with abnormal thickness of the waterproof layer corresponding to gaps between adjacent receiving slots, insufficient gap filling, etc. This helps eliminate the possibility of missed defects in the waterproof layer and ensures waterproofing reliability at a global level, preventing overall waterproofing failure caused by the spread of defects from other areas. On the other hand, relying on the full transparency of the waterproof member, the formation state of the pressure relief channel (extending from the area of the exposed hole to the periphery) can be completely observed, thereby allowing for verifying whether the thickness of the waterproof layer under the constraint of the first convex face meets pressure relief requirements and for checking whether the connection between the pressure relief channel and the surrounding waterproof layer is continuous and free of gaps or fractures. This reduces the risk of pressure relief path deviation due to connection defects and further enhances the comprehensiveness of pressure relief channel verification.

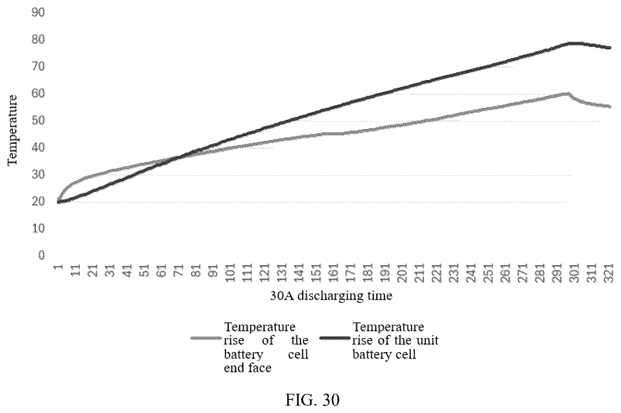

The present disclosure imposes no restrictions on the specific composition of the first material or the second material. In some implementation manners, the first material is a non-metal material with a thermal softening temperature of higher than or equal to 90° C. As shown in FIG. 30, during 30 A discharging of a 60V unit battery cell 21, the temperature rise of the battery cell end face reaches about 60° C. As current intensity increases, the temperature rise of the battery cell end face also escalates. In order to protect the unit battery cell 21, when the battery cell is overheated during charging/discharging, high-pressure and high-temperature flame ejection usually occurs at the first battery cell end face 211, at which time the temperature of the battery cell end face generally exceeds 100° C. By configuring the first material to be a non-metal material with a thermal softening temperature of higher than or equal to 90° C., the waterproof member 24 can autonomously soften during an abnormal temperature rise of the unit battery cell 21, enabling the abnormal unit battery cell 21 to rapidly break through the weak area of the waterproof member, thereby providing a safe pressure relief mechanism that reduces impact on adjacent unit battery cells 21 or battery cell assemblies 2 and avoids cascading thermal runaway events; meanwhile, during a normal temperature rise of the unit battery cell 21, it provides stable and effective waterproof performance unaffected by the temperature rise.

In another implementation manner, the first material is polycarbonate, polymethyl methacrylate, or transparent nylon. By configuring the first material as polycarbonate, polymethyl methacrylate, or transparent nylon, the waterproof member 24 can autonomously soften during an abnormal temperature rise of a unit battery cell 21, enabling the abnormal unit battery cell 21 to rapidly break through the weak area of the waterproof member, thereby providing a safe pressure relief mechanism that reduces impact on adjacent unit battery cells 21 or battery cell assemblies 2 and avoids cascading thermal runaway events; meanwhile, during a normal temperature rise of the unit battery cell 21, it provides stable and effective waterproof performance unaffected by the temperature rise.

In some embodiments, polycarbonate, polymethyl methacrylate, and transparent nylon all possess excellent visible light transmittance. For example, polymethyl methacrylate can achieve a transmittance of over 90%, polycarbonate has a transmittance of approximately 85%, and transparent nylon provides sufficient transmittance to meet the requirement for clearly observing internal conditions. These materials can stably achieve the design objective of transparency within the projection range of the exposed hole or overall transparency. Through the waterproof member made from these materials, operators are able to clearly observe whether the waterproof layer is uniformly applied, the presence of bubbles/voids, and the matching state between the pressure relief channel and the first convex face. This reduces issues of blurred observation and misjudgment of defects caused by insufficient material transmittance, ensuring the accurate implementation of visual inspection functionality. Moreover, polycarbonate, polymethyl methacrylate, and transparent nylon exhibit low optical distortion after molding, faithfully reproducing the actual state of the internal waterproof layer and pressure relief channel. These materials are capable of avoiding problems such as misjudgment of waterproof layer thickness or distortion of bubble size due to inherent optical deviations of the materials, further enhancing the accuracy of quality inspection and reducing the risk of waterproofing or pressure relief failure caused by inspection errors.

Additionally, polycarbonate offers superior impact resistance, polymethyl methacrylate provides outstanding weather resistance, and transparent nylon exhibits good temperature resistance and mechanical properties. All these materials are capable of meeting the operational requirements of tool battery packs during assembly (e.g., compression when pressing against the waterproof layer), transportation (vibration and impact), and usage (environmental temperature fluctuations). This reduces the risk of deformation during pressing or cracking during long-term use due to insufficient strength of the material of the waterproof member, which could otherwise affect the sealing effectiveness of the waterproof layer and the stability of the pressure relief channel.

In some embodiments, the second material may be reinforced polypropylene (PP+glass fiber), modified nylon (PA6+glass fiber), polybutylene terephthalate (PBT), or similar materials.

The waterproof member 24 has a positioning member 226, and the positioning member 226 is a positioning hole that engages with a positioning post arranged on the battery cell holder 22, where the positioning post has a size of 1 mm to 10 mm, thereby enabling effective positioning.

Referring to FIGS. 3 to 5, in some implementation manners, the waterproof member 24 has a positioning member 226, and the positioning member 226 is a positioning post with a size of 0.5 mm to 2 mm and engages with a positioning hole formed in the battery cell holder 22, where the positioning hole is capable of accommodating part or all of the positioning post.

Referring to FIGS. 3 to 5, in some implementation manners, the waterproof member 24 is connected to the battery cell holder 22 through, but not limited to, a mortise-and-tenon engagement structure, welding, adhesive bonding, or similar methods, ensuring a secure fit.

In some implementation manners, the waterproof member 24 is provided with a first convex face 2411 at a position of the exposed hole 222. The position of the exposed hole 222 refers to a space formed by the outer contour of the exposed hole 222 in a direction in which the unit battery cell 21 extends. A projection plane of the waterproof member 24 in the direction in which the unit battery cell 21 extends at least partially overlaps with a projection plane formed by the outer contour of the exposed hole 222 in the direction in which the unit battery cell 21 extends.

Referring to FIGS. 3 to 7, in some implementation manners, the battery cell assembly 2 further includes a waterproof layer 23 covering the exposed hole 222, the second end face 242 of the waterproof member 24 contacts the waterproof layer 23, and the waterproof layer 23 is capable of deforming under pressure from the waterproof member 24. That is, the waterproof layer 23 is disposed between the unit battery cell 21 and the waterproof member 24 and fills the gap between the unit battery cell 21 and the battery cell holder 22. In this case, the adhesive flows from the second end face 242 toward the unit battery cell 21, enters the battery cell holder 22, and under a pressing action of the waterproof member 24, further flows toward the battery cell holder 22, thereby further filling the gap between the unit battery cell 21 and the battery cell holder 22. Based on the pressing action of the waterproof member 24, the adhesive sets and cures within a space between the waterproof member 24 and the unit battery cell 21.

At this point, when the second end face 242 of the waterproof member 24 is pressed against the not-yet-dry waterproof layer 23, the second end face 242 of the waterproof member 24 exerts pressure on the waterproof layer 23. This pressure immediately forces the waterproof layer 23 to fill all microscopic gaps between the battery cell holder 22 and the waterproof member 24. The waterproof layer 23 is capable of deforming under the pressure from the waterproof member 24, achieving full filling between the battery cell holder 22 and the waterproof member 24. The final form of the waterproof layer 23 is not slowly formed over a long waiting period, and the pressure is capable of expelling excess solvent or moisture, further promoting the curing of the waterproof layer 23.

When the waterproof member 24 applies the pressure, the semi-fluid waterproof layer 23 is forced into these microscopic gaps. This deformation under the pressure is capable of compensating for the minor unevenness of the battery cell holder 22 and the waterproof member 24 due to manufacturing tolerances, resulting in a final sealing interface that is not a simple surface-contact structure but an integrated, seamless filling sealing structure with sealing performance superior to that of a coating formed naturally without pressure.

Furthermore, when the waterproof layer 23 cures under the pressure from the waterproof member 24, a certain amount of prestress is retained. This prestress ensures that the waterproof layer 23 maintains tight contact with the contacting surfaces on both sides at all times, effectively preventing gap formation due to material shrinkage or deformation, consequently greatly enhancing long-term sealing stability and durability. Referring to FIGS. 3 to 8, in some implementation manners, the second end face 242 has various forms, including but not limited to flat surfaces, concave-convex surfaces, or curved surfaces. In some implementation manners, the second end face 242 is a flat surface 24112, which is a plane set along a horizontal direction. When the unit battery cell 21 experiences thermal runaway and an internal pressure impacts a thin-walled area of the first convex face 2411, stress is evenly distributed across the entire flat surface 24112. The flat surface 24112 will reach the yield strength or fracture limit of its material and rupture, facilitating precise control of pressure relief and allowing for better management of the rupture pattern of the flat surface 24112. For example, the flat surface 24112 may be a smooth plane set along the horizontal direction, without protrusions or depressions.

The form of the flat surface 24112 ensures that when the pressure reaches a threshold, rupture does not occur randomly or in a tearing manner but in a controlled, integral manner. The flat surface 24112 deforms outward as a whole. Ultimately, upon reaching the limit, it rapidly ruptures along an edge of maximum stress (typically at the boundary between the flat surface 24112 and thicker areas), forming a neat pressure relief opening, thereby further ensuring the pressure relief effect.

Referring to FIG. 9, in some implementation manners, the second end face 242 is non-flat and has a second convex face 2421 protruding toward the end face of the unit battery cell 21 at the exposed hole 222, a distance L2b between the second convex face 2421 and the positive end face 2111 is more than or equal to 0.1 mm, or a distance L2a between the second convex face 2421 and the cap end face 21111 is more than or equal to 0.1 mm. By defining ranges of the distances L2a and L2b, the thickness of the weak area of the waterproof layer may be controlled to maintain effective waterproof protection while providing a well-defined and controlled pressure relief channel for abnormal conditions such as high pressure and high temperature. Furthermore, by defining ranges of the distances L2a and L2b, the thickness of the weak area may remain controllable and consistent during manufacturing, which not only ensures quality control in mass production but also enhances process stability.

In some implementation manners, the second end face 242 is non-flat and has a second convex face 2421 protruding toward the end face of the unit battery cell 21 at the exposed hole 222; and/or, the second convex face 2421 is pressed onto the waterproof layer 23 at the position of the exposed hole 222.

Based on the foregoing, in some implementation manners, a distance L2b between the second convex face 2421 and the positive end face 2111 is more than or equal to 0.1 mm and less than 2 mm, or a distance L2a between the second convex face 2421 and the cap end face 21111 is more than or equal to 0.1 mm and less than 2 mm. By defining ranges of the distances L2a and L2b, the thickness of the weak area of the waterproof layer may be controlled to maintain effective waterproof protection while providing a well-defined and controlled pressure relief channel for abnormal conditions such as high pressure and high temperature. Furthermore, by defining ranges of the distances L2a and L2b, the thickness of the weak area may remain controllable and consistent during manufacturing, which not only ensures quality control in mass production but also enhances process stability.

Based on the foregoing, in some implementation manners, a distance L2b between the second convex face 2421 and the positive end face 2111 is more than or equal to 0.5 mm and less than 1 mm, or a distance L2a between the second convex face 2421 and the cap end face 21111 is more than or equal to 0.5 mm and less than 1.5 mm. By defining ranges of the distances L2a and L2b, the thickness of the weak area of the waterproof layer may be controlled to maintain effective waterproof protection while providing a well-defined and controlled pressure relief channel for abnormal conditions such as high pressure and high temperature. Furthermore, by defining ranges of the distances L2a and L2b, the thickness of the weak area may remain controllable and consistent during manufacturing, which not only ensures quality control in mass production but also enhances process stability.

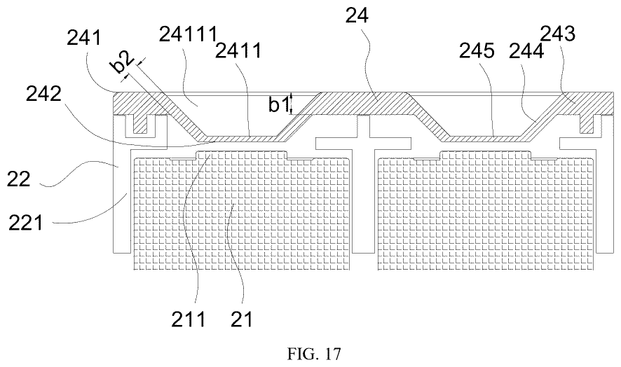

Based on the foregoing, in some implementation manners, a distance L2b between the second convex face 2421 and the positive end face 2111 is more than or equal to 0.3 mm and less than or equal to 0.8 mm, or a distance L2a between the second convex face 2421 and the cap end face 21111 is more than or equal to 0.3 mm and less than or equal to 1.2 mm. By defining ranges of the distances L2a and L2b, the thickness of the weak area of the waterproof layer may be controlled to maintain effective waterproof protection while providing a well-defined and controlled pressure relief channel for abnormal conditions such as high pressure and high temperature. Furthermore, by defining ranges of the distances L2a and L2b, the thickness of the weak area may remain controllable and consistent during manufacturing, which not only ensures quality control in mass production but also enhances process stability. Referring to FIGS. 17 and 20 to 22, in some implementation manners, the waterproof member 24 includes a main body portion 243, a first connecting portion 244, and a second connecting portion 245. For example, the main body portion 243 is in the form of a sheet, and its outer contour matches the end face contour of the second end of the battery cell holder 22, thereby ensuring that the main body portion 243 may completely cover the end face of the second end to achieve a sealed connection to the battery cell holder 22. The first connecting portion 244 is disposed between the main body portion 243 and the second connecting portion 245 to transitionally connect the main body portion 243 and the second connecting portion 245. The second connecting portion 245 is disposed opposite the first battery cell end face 211; the first face of the main body portion 243, the first face of the first connecting portion 244, and the first face of the second connecting portion 245 together form the first convex face 2411; and the second face of the main body portion 243, the second face of the first connecting portion 244, and the second face of the second connecting portion 245 together form the second convex face 2421. In an extension direction of a connecting line between the first end face 241 and the second end face 242, an offset exists between the first face of the second connecting portion 245 and the first face of the main body portion 243, forming a recessed space 24111 of the first convex face 2411.

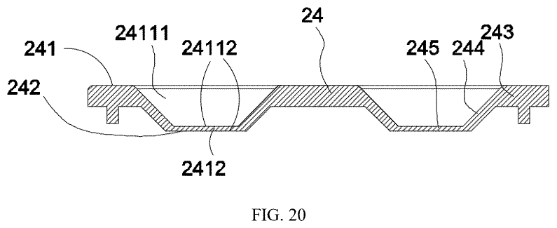

In some implementation manners, a vertical distance b1 between the first face and the second face of the main body portion 243 is different from a vertical distance b2 between the first face and the second face of the first connecting portion 244. That is, the thickness of the main body portion 243 is different from that of the first connecting portion 244. For example, as shown in FIGS. 20 to 22, the main body portion 243 may be designed thicker than the first connecting portion 244; alternatively, the main body portion 243 can be designed thinner than the first connecting portion 244. On this basis, the vertical distance b1 between the first face and the second face of the main body portion 243 may also be designed to be different from a vertical distance b3 between the first face and the second face of the second connecting portion 245. That is, the thickness of the main body portion 243 is different from that of the second connecting portion 245, for example, b1>b3, where the main body portion 243 is thicker than the second connecting portion 245; or the main body portion 243 could be thinner than the second connecting portion 245. Certainly, the vertical distance b2 between the first face and the second face of the first connecting portion 244 can also be designed to be different from the vertical distance b3 between the first face and the second face of the second connecting portion 245. That is, the thickness of the first connecting portion 244 is different from that of the second connecting portion 245. The first connecting portion 244 could be thicker than the second connecting portion 245, or the first connecting portion 244 could be thinner than the second connecting portion 245. For example, when the first connecting portion 244 is thinner than the second connecting portion 245, an inclined area of the first connecting portion forms a preset weak section. Under an internal pressure or external force, this inclined area is capable of preferentially yielding or rupturing. Thus, a larger-area rupture opening can be formed at the inclined area with a smaller triggering force, improving pressure relief/rupture efficiency and reducing impact on other structural parts.

Regarding the main body portion 243, it serves as a foundation of the entire waterproof member 24, bears a critical responsibility for forming a primary seal with the battery cell holder 22, and provides a stable platform for the entire pressure relief structure. Therefore, as an optional implementation manner, the main body portion 243 has the greatest thickness, with b1>b2. That is, the thickness of the main body portion 243 is greater than that of the first connecting portion 244. At the same time, the thickness of the main body portion 243 is greater than that of the second connecting portion 245, ensuring that the main body portion 243 may fit tightly against the battery cell holder 22 and effectively fill micro-level irregularities. As the foundation of the entire member, sufficient thickness endows the main body portion 243 with excellent resistance to bending and torsion.

When the battery pack is subjected to vibration or impact, the robust main body portion 243 maintains its shape stability, thereby protecting the more fragile first connecting portion 244 and second connecting portion 245 connected thereto. This prevents sealing failure or unintended pressure relief triggering due to overall deformation.

Furthermore, in some embodiments, b2>b3, meaning the thickness of the first connecting portion 244 is greater than that of the second connecting portion 245. On this basis, regarding the first connecting portion 244, it is a connecting part that connects the main body portion 243 and the second connecting portion 245. The thickness of the main body portion 243 differs from that of the first connecting portion 244, creating a stepped thickness change. When an internal pressure acts on the second connecting portion 245, stress is transmitted and concentrated along the first connecting portion 244, thereby guiding a deformation direction of the second connecting portion 245 under the pressure, namely, outward flipping or bulging rather than inward collapsing.

Simultaneously, since the first connecting portion 244 is relatively thin, it can sink between the main body portion 243 and the second connecting portion 245, thereby forming a recessed space 24111 together with the second connecting portion 245. The recessed space 24111 is a prerequisite for the first convex face 2411 to be able to deform outward, bulge, and even rupture.

Regarding the second connecting portion 245, it has the smallest thickness. As the thinnest part, when the pressure reaches a critical point, the second connecting portion 245 will undoubtedly become the first point to undergo structural failure. This ensures the uniqueness and certainty of the pressure relief action, reducing unpredictable damage to the main body portion 243 or elsewhere.

The variation in thickness creates a clear stress gradient, allowing energy to be guided and released in an orderly manner under impact, rather than causing random structural damage. It highly integrates three major functions, namely sealing, pressure relief guidance, and pressure relief triggering, into a single, simple component. By controlling the core physical parameter of thickness, it achieves extremely high reliability and manufacturability. Therefore, the waterproof member 24 highly integrates the three major functions, namely sealing, pressure relief guidance, and pressure relief triggering, into a single, simple component. By controlling the core physical parameter of thickness, it achieves extremely high reliability and manufacturability.

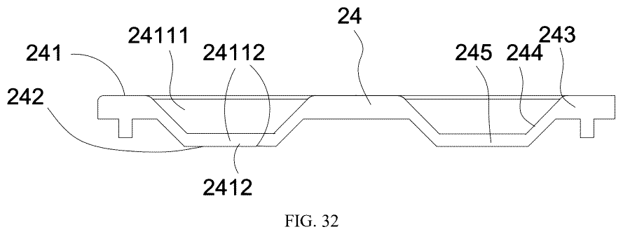

Referring to FIG. 32, in some implementation manners, b2<b3, meaning the first connecting portion 244 is thinner than the second connecting portion 245. Consequently, an inclined area of the first connecting portion 244 forms a preset weak section. Under an internal pressure or external force, this inclined area is capable of preferentially yielding or rupturing. Thus, a larger-area rupture opening can be formed at the inclined area with a smaller triggering force, improving pressure relief/rupture efficiency and reducing impact on other structural parts.

It should be noted here that the first face of the main body portion 243, the first face of the first connecting portion 244, and the first face of the second connecting portion 245 together form the first end face 241; and the second face of the main body portion 243, the second face of the first connecting portion 244, and the second face of the second connecting portion 245 together form the second end face 242.

Referring to Table 1, it presents test data and safety rating results corresponding to different b3 values. As can be seen from Table 1, a distance L1 between the first face and the second face of the second connecting portion 245 may be selected from 0.3 mm to 1.5 mm. The distance b3 in the range of 0.3 mm to 1.5 mm can achieve optimal compressive stress concentration while ensuring good mechanical strength and assembly, forming a precisely controlled weak area. When a unit battery cell experiences thermal runaway, it enables accurate triggering of directional pressure relief. This not only significantly reduces an internal battery pack space occupied by the waterproof member, adapting to the lightweight and thin design requirements of handheld tool battery packs, but also ensures the waterproof member possesses fundamental connection rigidity, reducing functional failure caused by too small overall thickness. In specific implementations, L1 may be 0.3 mm, 0.35 mm, 0.4 mm, 0.45 mm, 0.5 mm, 0.55 mm, 0.6 mm, 0.65 mm, 0.7 mm, 0.75 mm, 0.8 mm, 0.85 mm, 0.9 mm, 0.95 mm, 1.00 mm, 1.25 mm, 1.3 mm, 1.35 mm, 1.4 mm, 1.45 mm, or 1.5 mm. When L1 is 0.5 mm, optimal performance may be achieved.

TABLE 1

| | | | | | | Damage | |
|---|---|---|---|---|---|---|---|
| | Waterproof | Pressure | | Adjacent | | Rate | |
| | Wrapping | Relief | Burst | Battery | | During | |
| L1 | Depth | Delay | Pressure | Cell ΔT | Production | Transport | Comprehensive |
| (mm) | (mm) | (ms) | (bar) | (° C.) | Yield (%) | (%) | Safety Rating |
| 0.1 | 0.8 ± 0.3 | 6.5 ± 1.0 | 3.2 ± 0.3 | 30 ± 4 | 75.2 | 18.3 | Prohibited |
| 0.2 | 1.5 ± 0.3 | 7.8 ± 1.5 | 4.2 ± 0.3 | 35 ± 4 | 86.7 | 3.2 | For laboratory |
| | | | | | | | use only |
| 0.3 | 2.0 ± 0.3 | 9.5 ± 1.8 | 5.0 ± 0.4 | 38 ± 5 | 96.5 | 1.2 | Effective |
| 0.4 | 2.3 ± 0.2 | 10.8 ± 1.9 | 6.0 ± 0.4 | 40 ± 5 | 98 | 0.9 | Effective |
| 0.5 | 2.5 ± 0.3 | 12.7 ± 2.1 | 7.2 ± 0.5 | 42 ± 6 | 99.3 | 0.7 | Optimally |
| | | | | | | | effective |
| 0.6 | 2.4 ± 0.2 | 14.5 ± 2.3 | 7.5 ± 0.5 | 45 ± 6 | 99 | 0.6 | Effective |
| 1 | 2.2 ± 0.2 | 22.3 ± 3.4 | 8.0 ± 0.6 | 68 ± 8 | 99.1 | 0.3 | Effective |
| 1.5 | 1.9 ± 0.3 | 38.5 ± 4.9 | 9.0 ± 0.8 | 105 ± 12 | 99 | 0.1 | Pressure relief |
| | | | | | | | risk |
| 1.6 | 1.7 ± 0.2 | 42.1 ± 5.2 | 9.6 ± 0.9 | 118 ± 15 | 98.8 | 0.1 | Ineffective |
| 1.7 | 1.6 ± 0.2 | 45.0 ± 5.5 | 10.2 ± 1.0 | 130 ± 16 | 98.6 | 0.08 | Ineffective |
| 2 | 1.5 ± 0.3 | >50 | >11.0 | >150 | 98.5 | 0.05 | Thermal |
| | | | | | | | propagation |

In addition, in some implementation manners, as shown in FIG. 20, the first connecting portion 244 can also be designed in an inclined arrangement, and an inclination angle B of the first connecting portion 244 relative to a horizontal direction is 30° to 60°. For example, it may be 30°, 35°, 40°, 45°, 50°, 55°, or 60°. For consistent determination, a horizontal plane can be defined by a mounting reference plane S of the battery cell holder 22 facing the waterproof member 24, and a direction parallel to this horizontal plane is considered the horizontal direction. Therefore, when the inclination angle of the first connecting portion is 30° to 60°, the connection stress between the main body portion and the second connecting portion may be distributed along the inclined direction. Compared to angles<30° (where stress concentrates at connection endpoints) or >60° (where bending may easily occur under a vertical force), this range is capable of effectively reducing the local peak stress. Particularly when combined with a design where the main body portion is thicker than the first and second connecting portions, it is capable of balancing the stress differences between the thick-walled main body portion and the thin-walled connecting portions, and reducing the risk of cracking in the first connecting portion due to stress concentration and extending the service life of the waterproof member. Moreover, if the angle is too small, it would easily cause interference between the second connecting portion and the battery cell end face; if the angle is too large, it would occupy excessive lateral space. The aforementioned range ensures that the second connecting portion maintains a preset distance from the battery cell end face. Utilizing the principle of an inclined plane, the axial pressure of the airflow is vector-decomposed along the inclination angle B. The inclined plane increases the contact area of the high-temperature and high-pressure airflow, enhances heat conduction efficiency, further accelerates the softening of the waterproof member, and delays thermal propagation. This allows the pressure relief port to be opened with a smaller force and in a more controllable manner.

In some implementation manners, in this inclined arrangement, one end of the first connecting portion 244 is connected to the main body portion 243, and the other end of the first connecting portion 244 is connected to the second connecting portion 245. This results in an offset between the second connecting portion 245 and the main body portion 243 in an extension direction of a connecting line between the first end face 241 and the second end face 242. Combined with the aforementioned design of unequal thickness between the first connecting portion 244 and the second connecting portion 245, the inclined first connecting portion 244 undergoes directional elastic deformation when the end faces are pressed together: on the one hand, it decomposes the axial assembly load into axial and tangential components, improving the contact pressure and fit of the circumferential sealing line of the first convex face 2411; on the other hand, it provides deformation allowance for assembly tolerances, thermal expansion/contraction, and vibration between the battery cell end face 211 and the battery cell holder 22, reducing the risk of stress concentration and seal degradation. Furthermore, the inclined arrangement can create a slight slope around the periphery of the main body portion 243, facilitating the drainage of condensed water or splashed liquid along the outer side of the battery cell holder 22 and reducing the likelihood of liquid accumulation in the end face area.

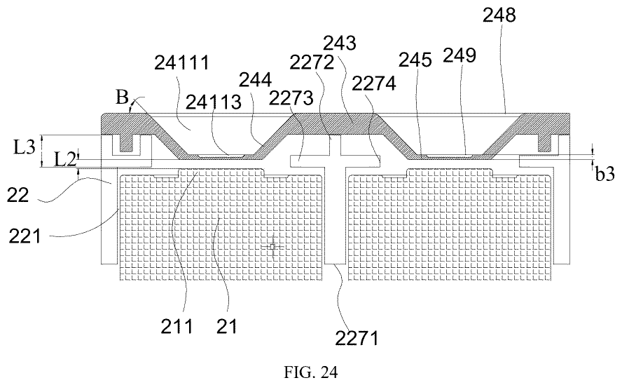

Referring to FIG. 24 and Tables 2 to 4, the distance L2 (including L2a, L2b) between the second face of the second connecting portion 245 and the battery cell end face of the unit battery cell 21 is 0.1 mm to 2 mm. Thus, the distance L2 within the range of 0.1 mm to 2 mm ensures that, with the lower limit of 0.1 mm, under the action of the assembly clamping force, the waterproof member (through the second convex face) will necessarily apply a sufficient and predictable compressive force to the waterproof layer covering the battery cell end face. This compressive force drives the directional flow and filling of the waterproof layer (such as thermal conductive gel or silicone). When the upper limit exceeds 2 mm, the waterproof layer cannot be effectively squeezed into the tiny gaps between the circumference of the battery cell and the inner wall of the receiving slot in the battery cell holder, leading to insufficient side sealing and a significant reduction in waterproof effectiveness. An appropriate distance L2 (0.1-2 mm), combined with the clamping force, ensures that the waterproof layer is compressed on the battery cell end face into a relatively uniform and controllable sealing layer, covering both the end face and, due to the pressure, fully wetting and filling the side gaps, forming a 360° sealing ring. The top surface of the first convex face is located very close to the battery cell end face (especially in the area of the exposed hole). This allows the gas and pressure generated during thermal runaway to instantly and directly impact the first convex face, greatly shortening the pressure relief response time.

In specific implementations, L2 may be 0.1 mm, 0.3 mm, 0.4 mm, 0.5 mm, 0.8 mm, 1.0 mm, 1.1 mm, 1.2 mm, 1.3 mm, 1.4 mm, 1.5 mm, 1.6 mm, 1.7 mm, 1.8 mm, or 2 mm. Here, the battery cell end face refers to an end face of the unit battery cell 21 close to the waterproof member 24. The first thickness L3 is a sum of the heights of a second isolation section 2272 and a third isolation section 2273 and/or a fourth isolation section 2274. The height L2 of a potting area serves the functions of sealing and isolation. When L3 is less than 5 mm, causing L2 to be 0.1-2 mm, the second isolation section 2272 makes a path between adjacent connecting tabs more tortuous, an isolation rib 227 increases the creepage distance, preventing the waterproof layer 23 from flowing into non-critical areas, and an isolation slot blocks electrolyte migration. Even if single-point sealing fails, the electrolyte is confined within an independent compartment.

TABLE 2
Comparison of Waterproof Sealing Performance Data

| L2 | Sealing Pass | | Side Wrapping |
|---|---|---|---|
| (mm) | Rate | Failure Mode | Coverage Rate |
| 0.1 | 92% | No failure, but long-term | 91% |
| | | fatigue risk | |
| 0.2 | 94% | No failure | 93% |
| 0.3 | 95.1% | No failure | 96% |
| 0.4 | 96% | No failure | 98% |
| 0.6 | 97.5% | No failure | 100% |
| 0.8 | 98% | No failure | 100% |
| 1 | 99% | No failure | 100% |
| 1.2 | 99.50% | No failure (IPX7 | 100% |
| | | certified) | |
| 1.4 | 99.30% | No failure (passed | 98% |
| | | 2,000 h aging test) | |
| 1.6 | 95% | Weakened edge filling | 95% |
| 1.8 | 82% | Water seepage rate ↑3x | 90% |
| | | in high humidity | |
| | | environment | |
| 2 | 65% | Failure of sealing ring | 80% |
| | | effect | |
| 2.2 | 45% | Discontinuous | 60% |
| | | waterproof layer flow | |
| 2.4 | 30% | No side wrapping on | 20% |
| | | battery cell | |
| 2.6 | 18% | Interface separation | 5% |
| 2.8 | 5% | Complete loss of sealing | 0% |
| 3 | 0% | Direct moisture intrusion | 0% |

TABLE 3
Comparison of Production Efficiency Data

| | Production | | | | |
|---|---|---|---|---|---|
| L2 | Takt Time | | Process | | Automation |
| (mm) | per Unit | | Complexity | Yield | Compatibility |
| 0.1 | 36 | s/unit | Precise pressure | 89% | Effective |
| | | | control required | | |
| 0.2 | 38 | s/unit | Precise pressure | 90% | Effective |
| | | | control required | | |
| 0.4 | 35 | s/unit | High-precision | 91% | Effective |
| | | | positioning | | |
| | | | required | | |
| 0.6 | 42 | s/unit | Cooling required | 93% | Effective |
| | | | to prevent | | |
| | | | adhesion | | |
| 0.8 | 40 | s/unit | Pressing time + | 95% | Effective |
| | | | 2 s | | |
| 1 | 25 | s/unit | Instant assembly | 98% | Effective |
| | | | without curing | | |
| 1.2 | 24 | s/unit | Fully compatible | 99% | Effective |
| | | | with automation | | |
| 1.4 | 25 | s/unit | No special | 98% | Effective |
| | | | process | | |
| | | | requirements | | |
| 1.6 | 26 | s/unit | Routine | 96% | Effective |
| | | | production | | |
| 1.8 | 27 | s/unit | Waterproof layer | 92% | Effective |
| | | | viscosity | | |
| | | | adjustment required | | |
| 2 | 28 | s/unit | High tolerance for | 88% | Effective |
| | | | error | | |
| 2.2 | 22 | s/unit | No pressing | 75% | Effective |
| | | | control required | | |
| 2.4 | 20 | s/unit | Direct covering | 65% | Effective |
| 2.6 | 18 | s/unit | Extremely simple | 50% | Effective |
| | | | process | | |
| 2.8 | 25 | s/unit* | 30% rework rate | 40% | Effective |
| 3 | 30 | s/unit* | Rework due to | 25% | Ineffective |
| | | | waterproof layer | | |
| | | | displacement | | |

TABLE 4
Comparison of Thermal Runaway Pressure
Relief Response and Reliability Data

| | Pressure | Pressure | Thermal | |
|---|---|---|---|---|
| | Relief | Relief | Propagation | |
| L2 | Response | Success | Suppression | |
| (mm) | Time | Rate | Rate | Structural Risk |
| 0.1 | 0.1 ms | 90% | 90% | Fatigue life ↓30% |
| 0.2 | 0.2 ms | 93% | 92% | Fatigue life ↓20% |
| 0.4 | 0.3 ms | 94% | 93% | No risk |
| 0.6 | 0.5 ms | 95% | 93% | No risk |
| 0.8 | 0.5 ms | 99% | 95% | No risk |
| 1 | 0.6 ms | 99% | 98% | No risk |
| 1.2 | 0.6 ms | 100% | 98.70% | No risk (optimal |
| | | | | balance point) |
| 1.4 | 0.7 ms | 99% | 98.50% | No risk |
| 1.6 | 0.8 ms | 97% | 97% | No risk |
| 1.8 | 1.0 ms | 90% | 92% | Rupture threshold |
| | | | | ↑10% |
| 2 | 1.2 ms | 80% | 85% | Pressure relief |
| | | | | delay |
| 2.2 | No response | 45% | 60% | 3x burst pressure |
| | | | | required |
| 2.4 | No response | 30% | 40% | Lateral propagation |
| | | | | intensified |
| 2.6 | No response | 10% | 20% | Chain thermal |
| | | | | runaway risk ↑5x |
| 2.8 | — | 0% | 0% | Whole pack |
| | | | | explosion |
| 3 | — | 0% | 0% | Complete failure of |
| | | | | pressure relief |
| | | | | mechanism |

Referring to FIGS. 5 to 12, in some implementation manners, the recessed space 24111 includes a first opening 248 formed at an intersection of the first face of the main body portion 243 and the first face of the first connecting portion 244, and an area of the second face of the second connecting portion 245 is 40% to 70% of a projected area of the first opening, for example, 40%, 45%, 50%, 55%, 60%, 65%, or 70%. Table 5 shows performance parameters corresponding to different percentage ratios of the area of the second face of the second connecting portion 245 relative to the aperture area of the exposed hole 222.

TABLE 5
Reference Exposed Hole Area -
18650: ≈200 mm², 21700: ≈300 mm²

| | | | |
|---|---|---|---|
| 10% | Pressure Relief | 1.5 | 1.8 |
| | Response Time (ms) | | |
| | Pressure Relief | 68% | 62% |
| | Success Rate | | |
| | Thermal | 55% | 48% |
| | Propagation | | |
| | Suppression Rate | | |
| | Sealing Pass Rate | 65% | 60% |
| | (IPX7) | | |
| | Failure Mode | Waterproof layer | Micro-cracks + |
| | | extrusion + | waterproof |
| | | structural | extrusion |
| | | deformation | |
| | Production Line | 78% | 72% |
| | Yield | | |
| 20% | Pressure Relief | 1.5 | 1.3 |
| | Response Time (ms) | | |
| | Pressure Relief | 80% | 73% |
| | Success Rate | | |
| | Thermal | 70% | 65% |
| | Propagation | | |
| | Suppression Rate | | |
| | Sealing Pass Rate | 75% | 70% |
| | (IPX7) | | |
| | Failure Mode | Local waterproof | Structural |
| | | layer | deformation (30%) + |
| | | extrusion (35%) | edge water seepage |
| | Production Line | 85% | 80% |
| | Yield | | |
| 30% | Pressure Relief | 0.7 | 0.9 |
| | Response Time (ms) | | |
| | Pressure Relief | 90% | 83% |
| | Success Rate | | |
| | Thermal | 85% | 78% |
| | Propagation | | |
| | Suppression Rate | | |
| | Sealing Pass Rate | 92% | 87% |
| | (IPX7) | | |
| | Failure Mode | Local insufficient | Weak edge |
| | | filling (8%) | sealing (12%) |
| | Production Line | 90% | 83% |
| | Yield | | |
| 40% | Pressure Relief | 0.4 | 0.5 |
| | Response Time (ms) | | |
| | Pressure Relief | 99% | 97% |
| | Success Rate | | |
| | Thermal | 97% | 94% |
| | Propagation | | |
| | Suppression Rate | | |
| | Sealing Pass Rate | 99% | 96% |
| | (IPX7) | | |
| | Failure Mode | None | Micro-cracks (3%, |
| | | | eliminated after |
| | | | structural |
| | | | reinforcement) |
| | Production Line | 99% | 97% |
| | Yield | | |
| 50% | Pressure Relief | 0.5 | 0.6 |
| | Response Time (ms) | | |
| | Pressure Relief | 98% | 99% (after structural |
| | Success Rate | | optimization) |
| | Thermal | 96% | 97% |
| | Propagation | | |
| | Suppression Rate | | |
| | Sealing Pass Rate | 98% | 98% |
| | (IPX7) | | |
| | Failure Mode | Uneven pressing | None |
| | | stress (2%) | |
| | Production Line | 98% | 98% (after |
| | Yield | | optimization) |
| 60% | Pressure Relief | 0.6 | 0.8 |
| | Response Time (ms) | | |
| | Pressure Relief | 95% | 92% |
| | Success Rate | | |
| | Thermal | 93% | 90% |
| | Propagation | | |
| | Suppression Rate | | |
| | Sealing Pass Rate | 96% | 94% |
| | (IPX7) | | |
| | Failure Mode | Pressure relief | Pressure relief |
| | | delay (5%) | delay (8%) |
| | Production Line | 95% | 92% |
| | Yield | | |
| 70% | Pressure Relief | 0.7 | 0.9 |
| | Response Time (ms) | | |
| | Pressure Relief | 93% | 90% |
| | Success Rate | | |
| | Thermal | 90% | 87% |
| | Propagation | | |
| | Suppression Rate | | |
| | Sealing Pass Rate | 95% | 93% |
| | (IPX7) | | |
| | Failure Mode | Pressure relief | Pressure relief |
| | | delay (7%) | delay (10%) |
| | Production Line | 94% | 91% |
| | Yield | | |
| 80% | Pressure Relief | 2.5 | 3 |
| | Response Time (ms) | | |
| | Pressure Relief | 55% | 50% |
| | Success Rate | | |
| | Thermal | 50% | 45% |
| | Propagation | | |
| | Suppression Rate | | |
| | Sealing Pass Rate | 88% | 85% |
| | (IPX7) | | |
| | Failure Mode | Pressure relief | Pressure relief |
| | | blockage (45%) | blockage (50%) + |
| | | | edge water seepage |
| | Production Line | 86% | 82% |
| | Yield | | |
| 90% | Pressure Relief | Failure (>10 ms) | Failure (>10 ms) |
| | Response Time (ms) | | |
| | Pressure Relief | <10% | <5% |
| | Success Rate | | |
| | Thermal | 0% | 0% |
| | Propagation | | |
| | Suppression Rate | | |
| | Sealing Pass Rate | 80% | 75% |
| | (IPX7) | | |
| | Failure Mode | Battery cell | Fire |
| | | explosion + module | |
| | | burn-out | |
| | Production Line | 82% | 78% |
| | Yield | | |

Alternatively, in some implementation manners, the recessed space 24111 includes a first opening 248 formed at an intersection of the first face of the main body portion 243 and the first face of the first connecting portion 244, and a second opening 249 formed at an intersection of the first face of the first connecting portion 244 and the first face of the second connecting portion 245, and a projected area of the second opening 249 is 40% to 70% of an area of the first opening 248, for example, 40%, 45%, 50%, 55%, 60%, 65%, or 70%. That is to say, the second opening 248 is an opening with a reduced area relative to the first opening 249, causing the recessed space 24111 to gradually contract from the first opening 249 toward the second opening 248.

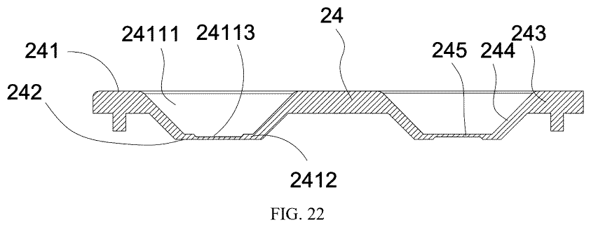

Referring to FIG. 22, in some implementation manners, the waterproof member 24 has a first end face 241 away from the battery cell holder 22, and the first end face 241 is provided with a first groove 24113 recessed toward the second end face 242; or, the second end face 242 is provided with a second groove 24114 recessed toward the first end face 241.

Referring to Table 6, it is an analysis and comparison table of area ratios and corresponding indicators. An area of the first groove 24113 or the second groove 24114 is 30% to 60% of a projected area of the first battery cell end face 211 onto the second end face 242, for example, 30%, 33%, 35%, 38%, 40%, 43%, 45%, 48%, 50%, 53%, 55%, 58%, or 60%.

TABLE 6

| Area | | 18650 | 21700 | |
|---|---|---|---|---|
| Ratio | Indicator | Performance | Performance | Key Data Verification |
| 10% | Pressure | 1.8 | 2.2 | High-pressure airflow |
| | Relief | | | dispersion (airflow velocity |
| | Response | | | only 40 m/s for 18650, 35 |
| | Time (ms) | | | m/s for 21700) |
| | Pressure | 65% | 58% | Unexpected rupture rate |
| | Relief | | | 32% for 18650 (vibration |
| | Success Rate | | | test), up to 40% for 21700 |
| | Thermal | 50% | 42% | Average temperature rise of |
| | Propagation | | | adjacent battery cells: |
| | Suppression | | | 230° C. for 18650, 250° C. for |
| | Rate | | | 21700 |
| | Sealing Pass | 60% | 55% | Waterproof layer extrusion |
| | Rate (IPX7) | | | rate: 45% for 18650, 50% |
| | | | | for 21700 (salt spray test to |
| | | | | check for water ingress) |
| | Failure Mode | Waterproof | Structural | Micro-crack rate of 25% |
| | | layer | deformation + | due to stress concentration |
| | | extrusion + | waterproof | for 21700 |
| | | unexpected | extrusion | |
| | | rupture | | |
| | Production | 75% | 70% | Main rework reason: circuit |
| | Line Yield | | | board contaminated by |
| | | | | waterproof material |
| | | | | (rework rate 25% for |
| | | | | 18650, 30% for 21700) |
| 20% | Pressure | 1.2 | 1.5 | Gas accumulation delay for |
| | Relief | | | 21700 (airflow diffusion |
| | Response | | | shown by thermal imaging) |
| | Time (ms) | | | |
| | Pressure | 78% | 70% | Pressure relief failure rate |
| | Relief | | | 30% for 21700 (due to peak |
| | Success Rate | | | pressure of 2.8 MPa > |
| | | | | structural strength of 2.5 |
| | | | | MPa) |
| | Thermal | 65% | 60% | Temperature rise of |
| | Propagation | | | adjacent battery cells: |
| | Suppression | | | 195° C. for 18650, 210° C. for |
| | Rate | | | 21700 |
| | Sealing Pass | 70% | 65% | CT scan: filling rate 70% |
| | Rate (IPX7) | | | for 18650, only 65% for |
| | | | | 21700 (evident edge voids) |
| | Failure Mode | Local | Structural | Waterproof member |
| | | waterproof | deformation | warpage deformation rate |
| | | layer | (25%) + edge | 18% for 21700 |
| | | extrusion | water seepage | |
| | | (30%) | | |
| | Production | 82% | 78% | Scrap rate 22% due to |
| | Line Yield | | | structural deformation for |
| | | | | 21700 |
| 30% | Pressure | 0.8 | 1 | Insufficient pressure relief |
| | Relief | | | area for 21700 (0.8 ms |
| | Response | | | required to accumulate |
| | Time (ms) | | | energy) |
| | Pressure | 92% | 85% | Pressure relief delay |
| | Relief | | | leading to 5% battery cell |
| | Success Rate | | | rupture for 21700 (vs 2% |
| | | | | for 18650) |
| | Thermal | 88% | 82% | Temperature rise of |
| | Propagation | | | adjacent battery |
| | Suppression | | | cells: ≤165° C. for |
| | Rate | | | 18650, ≤180° C. for 21700 |
| | Sealing Pass | 95% | 90% | Edge filling rate 88% for |
| | Rate (IPX7) | | | 21700 (94% for 18650), |
| | | | | perimeter difference |
| | | | | leading to weak sealing |
| | | | | areas |
| | Failure Mode | Local | Weak edge | 8% samples experiencing |
| | | insufficient | sealing (8%) | edge water seepage during |
| | | filling (5%) | | salt spray tests for 21700 |
| | Production | 92% | 85% | Compatibility tolerance ±0.4 |
| | Line Yield | | | mm for 18650, only ±0.3 mm |
| | | | | for 21700 |
| 40% | Pressure | 0.5 | 0.6 | Optimal airflow velocity: |
| | Relief | | | 120 m/s for 18650, 100 m/s |
| | Response | | | for 21700 |
| | Time (ms) | | | |
| | Pressure | 99% | 97% | 200 thermal runaway tests: |
| | Relief | | | zero failure for 18650, 3 |
| | Success Rate | | | failures for 21700 (all due |
| | | | | to battery cell |
| | | | | manufacturing defects) |
| | Thermal | 96% | 93% | Temperature rise of |
| | Propagation | | | adjacent battery cells: |
| | Suppression | | | 142° C. for 18650, 155° C. for |
| | Rate | | | 21700 (both < thermal |
| | | | | runaway threshold 170° C.) |
| | Sealing Pass | 99% | 96% | CT filling rate: 98% for |
| | Rate (IPX7) | | | 18650, 96% for 21700 |
| | | | | (high fluidity silicone |
| | | | | compensating for perimeter |
| | | | | disadvantage) |
| | Failure Mode | None | Micro-cracks | 2% micro-cracks caused by |
| | | | (2%, eliminated | vibration test before |
| | | | after structural | reinforcement for 21700 |
| | | | reinforcement) | |
| | Production | 98% | 96% | Process window ±0.3 mm |
| | Line Yield | | | for 18650, ±0.25 mm for |
| | | | | 21700 |
| 50% | Pressure | 0.6 | 0.7 | Slight airflow disturbance |
| | Relief | | | for 18650 (velocity |
| | Response | | | dropping to 110 m/s) |
| | Time (ms) | | | |
| | Pressure | 97% | 98% (after | Thickness increased by 0.2 |
| | Relief | | structural | mm, pressure resistance |
| | Success Rate | | optimization) | rising to 3.0 MPa > thermal |
| | | | | runaway peak of 2.8 MPa |
| | | | | for 21700 |
| | Thermal | 94% | 95% | Pressure relief |
| | Propagation | | | directionality improved, |
| | Suppression | | | temperature rise of adjacent |
| | Rate | | | battery cells dropping to |
| | | | | 150° C. for 21700 |
| | Sealing Pass | 97% | 97% | Edge filling rate rising to |
| | Rate (IPX7) | | | 95% for 21700 (R0.5 mm |
| | | | | fillet added at root) |
| | Failure Mode | Uneven | None | Occasional uneven |
| | | pressing | | waterproof layer thickness |
| | | stress (3%) | | for 18650 |
| | Production | 96% | 97% (after | Dedicated solution cost |
| | Line Yield | | optimization) | ↑12% for 21700, but yield |
| | | | | surpassing 18650 |
| 60% | Pressure | 0.7 | 0.9 | Excessive coverage leading |
| | Relief | | | to airflow resistance ↑ |
| | Response | | | (velocity 100 m/s for |
| | Time (ms) | | | 18650, 80 m/s for 21700) |
| | Pressure | 93% | 90% | Pressure relief delay rate |
| | Relief | | | 7% for 18650, 10% for |
| | Success Rate | | | 21700 (probability of |
| | | | | covering pressure relief |
| | | | | hole ↑) |
| | Thermal | 90% | 87% | Temperature rise of |
| | Propagation | | | adjacent battery cells: |
| | Suppression | | | 160° C. for 21700 |
| | Rate | | | (approaching safety |
| | | | | threshold) |
| | Sealing Pass | 94% | 92% | Uneven pressure |
| | Rate (IPX7) | | | distribution leading to 6% |
| | | | | local unfilled rate for 18650 |
| | Failure Mode | Pressure | Pressure relief | 10% battery cells rupturing |
| | | relief | delay (10%) | internally in thermal |
| | | delay (7%) | | runaway experiments for |
| | | | | 21700 |
| | Production | 93% | 90% | Hot pressing-caused |
| | Line Yield | | | warpage rate of waterproof |
| | | | | member: 5% for 18650, 8% |
| | | | | for 21700 |
| 70% | Pressure | 2.1 | 2.8 | Physical barrier effect: |
| | Relief | | | airflow velocity only 40 m/s |
| | Response | | | for 21700 (50 m/s for |
| | Time (ms) | | | 18650) |
| | Pressure | 62% | 55% | Pressure relief blockage |
| | Relief | | | rate 38% for 18650, up to |
| | Success Rate | | | 45% for 21700 (coverage |
| | | | | area forming a “sealing |
| | | | | lid”) |
| | Thermal | 55% | 48% | Chain thermal runaway: |
| | Propagation | | | temperature rise of adjacent |
| | Suppression | | | battery cells: >210° C. for |
| | Rate | | | 21700, >200° C. for 18650 |
| | Sealing Pass | 85% | 80% | Insufficient edge pressure: |
| | Rate (IPX7) | | | water seepage rate 15% for |
| | | | | 18650, 20% for 21700 |
| | Failure Mode | Pressure | Pressure relief | >80% of pressure relief |
| | | relief | blockage | hole area covered by the |
| | | blockage | (45%) + edge | waterproof member shown |
| | | (38%) | water seepage | through teardown |
| | Production | 88% | 83% | Warpage rate 12% of |
| | Line Yield | | | waterproof member for |
| | | | | 21700 (poor hot press |
| | | | | process) |
| 80% | Pressure | 3 | 4.5 | Airflow nearly stagnant |
| | Relief | | | (velocity 20 m/s for 18650, |
| | Response | | | 15 m/s for 21700) |
| | Time (ms) | | | |
| | Pressure | 45% | 35% | Thermal runaway-caused |
| | Relief | | | rupture rate 65% for 21700 |
| | Success Rate | | | (pressure relief channel |
| | | | | completely blocked) |
| | Thermal | 38% | 30% | Multi-battery cell chain |
| | Propagation | | | reaction: propagation rate |
| | Suppression | | | 62% for 18650, up to 70% |
| | Rate | | | for 21700 |
| | Sealing Pass | 82% | 78% | Pressure <0.2 MPa, leading |
| | Rate (IPX7) | | | to edge sealing failure |
| | | | | (water seepage rate 18% for |
| | | | | 18650) |
| | Failure Mode | Chain | Battery cell | Holder ignition by high- |
| | | thermal | rupture + | temperature jet (melting of |
| | | runaway + | structural | low-melting-point PP |
| | | edge sealing | meltdown | material for 21700) |
| | | failure | | |
| | Production | 85% | 80% | Rework cost being 3 times |
| | Line Yield | | | that of Group B |
| 90% | Pressure | Failure (>10 | Failure (>10 | Thermal runaway pressure |
| | Relief | ms) | ms) | failing to breach the |
| | Response | | | covering layer |
| | Time (ms) | | | |
| | Pressure | <10% | <5% | Battery cell casing rupture |
| | Relief | | | in 90% of tests |
| | Success Rate | | | |
| | Thermal | 0% | 0% | Thermal propagation rate |
| | Propagation | | | 100% (module burn-out) |
| | Suppression | | | |
| | Rate | | | |
| | Sealing Pass | 75% | 70% | Only central area sealed, |
| | Rate (IPX7) | | | water seepage at all edges |
| | Failure Mode | Battery cell | Fire | Fire control system |
| | | explosion + | | triggered by thermal |
| | | module burn- | | runaway experiment |
| | | out | | |
| | Production | 80% | 75% | Scrapped upon production |
| | Line Yield | | | (shipment prohibited due to |
| | | | | safety risk) |

Referring to FIG. 22, in some implementation manners, the first convex face 2411 is provided with a first groove 24113 recessed toward the second end face 242. In this case, the first groove 24113 communicates with the recessed space 24111. The presence of the first groove 24113 essentially further thins the already thin first convex face 2411. When the internal pressure of the battery cell holder increases, the bottom of the first groove 24113 becomes the point of maximum and most concentrated stress on the entire pressure relief structure, facilitating precise rupture. In some implementation manners, the first groove 24113 is a square groove, a ring-shaped groove, or a strip groove, and is a structure with an inwardly recessed space.

Simultaneously, the recessed space 24111 defines, at a macro-structural level, a thin-walled area intended for pressure relief. By further thinning the entire area, it ensures that this area will respond first, before any other part of the battery pack, when the pressure reaches a dangerous level. This achieves rupture not occurring randomly at some location on the flat surface 24112, but precisely starting from the root of the first groove 24113 and highly likely propagating along the path of the first groove 24113. The guided rupture typically forms a more regular and larger-opening pressure relief port. Compared to irregular and narrow cracks caused by random tearing, this design allows the high-pressure gas to be discharged more smoothly and quickly, thereby more effectively reducing internal pressure and suppressing thermal diffusion.

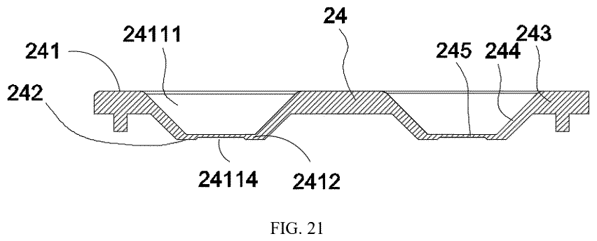

Referring to FIG. 21, in some implementation manners, the second convex face 2421 is provided with a second groove 24114 recessed toward the first end face 241. That is, the second groove 24114 is disposed on a surface of the first convex face 2411 facing away from the recessed space 24111. The second groove 24114 can be a square groove, a ring-shaped groove, or a strip groove, and is a structure with an inwardly recessed space.

The second groove 24114 is a groove recessed from the outside in, creating an extremely weak local area. This area is thinner than the already thinned wall around it due to the “recessed space 24111”. The recessed space 24111 still forms a thin-walled area, which isolates the entire pressure relief structure from the housing and thins its overall thickness, creating the basic conditions for pressure relief. Since the second groove 24114 creates an extremely weak point, it can trigger rupture at a relatively lower pressure. This means the pressure relief mechanism intervenes earlier, beginning to release pressure at an earlier stage of thermal runaway, thereby gaining valuable time to suppress thermal diffusion and providing a higher safety margin.

In another implementation manner, it is also possible to design the first end face 241 and the second end face 242 to be provided with a first groove 24113 and a second groove 24114, respectively. The opening directions of the first groove 24113 and the second groove 24114 are opposite. The widths of the first groove 24113 and the second groove 24114 may be equal or unequal, which is not specifically limited herein. Regarding the first groove 24113, it is provided on the first end face 241 away from the battery cell holder 22. The boundary of the first groove 24113 defines the maximum outline along which the first convex face 2411 can tear when rupturing. When an internal pressure impacts this area, it will tear along this preset groove boundary. Therefore, the area of the first groove 24113 directly determines the opening area of the final pressure relief port. The area of the first groove 24113 is 30% to 60% of the projected area of the first battery cell end face 211 onto the second end face 242. This area ensures that the pressure relief port is sufficiently large to release all the energy from the battery cell eruption at the fastest speed, reducing internal pressure accumulation; yet it is also small enough to ensure the structural integrity under non-essential conditions and the controllability during the pressure relief process.

Regarding the second groove 24114, it creates a weakest local area by reducing material thickness from the inside. The size of this area directly affects the pressure required to trigger rupture. The area of the second groove 24114 is 30% to 60% of the projected area of the first battery cell end face 211 onto the second end face 242. This area ensures that the second groove 24114 can effectively create a stress concentration point, significantly reducing the initiation pressure for pressure relief and achieving a rapid response, while also not overly compromising the overall structural strength of the first convex face 2411, ensuring reliability under normal operating conditions. In some implementation manners, the area of the second groove 24114 is 30% of the projected area of the first battery cell end face 211 onto the second end face 242. Alternatively, the area of the second groove 24114 is 60% of the projected area of the first battery cell end face 211 onto the second end face 242, which is not specifically limited herein.

For battery cells with different energy densities or different chemical systems, the area of the first groove 24113 or the second groove 24114 may be fine-tuned within this 30% to 60% range. For cells with higher energy, an area closer to 60% may be selected; for battery cells with lower energy, an area closer to 30% may be selected. This achieves flexibility and specificity in design, finds the optimal balance between “rapid pressure relief” and “structural strength”, reduces the two extreme scenarios of insufficient pressure relief or excessively weak structure caused by improper design, and ensures that the pressure relief function performs both reliably and efficiently under any circumstances.

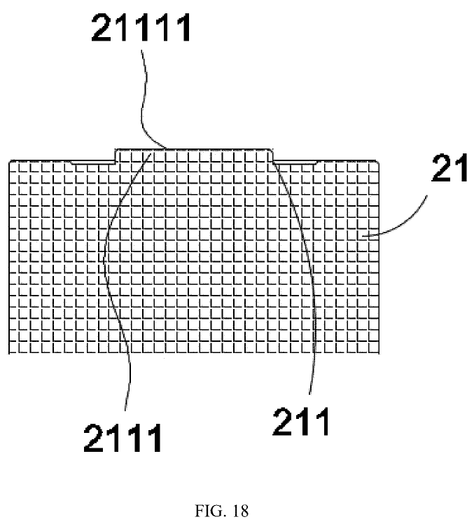

Referring to FIGS. 17 and 18, in some implementation manners, the unit battery cell 21 has a battery cell end face facing the waterproof member 24, an area of the second face of the second connecting portion 245 is 30% to 60% of an end face area of the battery cell end face, and/or an area of the first face of the second connecting portion 245 is 30% to 60% of the end face area of the battery cell end face. This range ensures that the second connecting portion 245 is capable of maximizing the utilization of the pressure amplification effect, and achieving rapid triggering under low pressure, while also being large enough to effectively capture the core energy ejected by the unit battery cell 21, ensuring the inevitability of triggering. The ultimate purpose of pressure relief is to rapidly discharge the high-temperature and high-pressure gas inside the battery pack and prevent thermal propagation. The pressure relief flow rate is directly related to the opening area.

The area of 30% to 60% serves not only as the “force-bearing area” during triggering but also as the effective pressure relief area of the second connecting portion 245. Simultaneously, it is capable of forming a massive discharge channel within milliseconds, allowing the pressure inside the battery pack to rapidly drop to a safe level and effectively block heat transfer to adjacent battery cells.

At this point, energy focusing causes the pressure relief valve to rupture from its weakest central area, ensuring the symmetry and controllability of the pressure relief process. Once the second connecting portion 245 opens, the focused airflow forms a powerful and directionally concentrated jet that is discharged at high speed along a preset space. This reduces the chaotic and disorderly movement of high-temperature gas inside the battery pack, greatly enhancing safety.

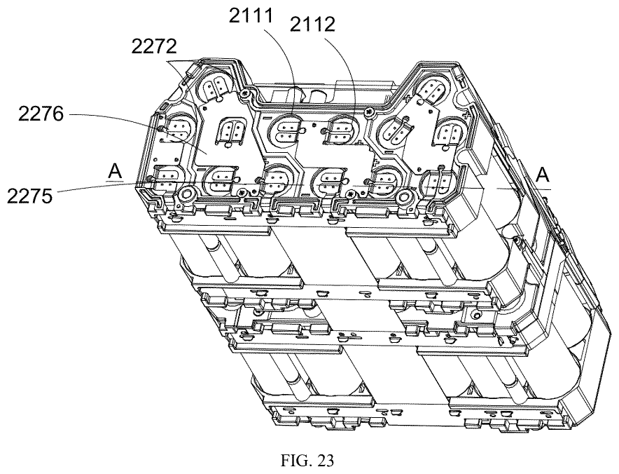

Referring to FIG. 23, in some implementation manners, the battery cell holder 22 is provided with an isolation rib 227 including a first isolation section 2271 and a second isolation section 2272, where the first isolation section 2271 is disposed parallel to an extension direction of the battery cell between the first battery cell end face 211 and the second battery cell end face 212, and the second isolation section 2272 extends parallel to the extension direction of the battery cell and protrudes beyond the first battery cell end face 211; the second isolation section 2272 encloses an accommodating area 2275 on the end face of the second end 224; the unit battery cell 21 is provided in a plurality, and the plurality of unit battery cells 21 are connected to the same battery cell holder 22; within the accommodating area 2275, the unit battery cells 21 are in an electrically connected state; and between two adjacent unit battery cells, the first battery cell end face 211 of one unit battery cell 21 and the second battery cell end face 212 of the other unit battery cell 21 are exposed to the accommodating area 2275.

Here, the first battery cell end face 211 and the second battery cell end face 212 are two battery cell end faces with opposite polarities. That is to say, when the first battery cell end face 211 is a positive end face, the second battery cell end face 212 is a negative end face.

In some cases, the second isolation section 227 divides a large area into multiple smaller accommodating portions, exponentially shortening the maximum flow distance of the waterproof layer 23 within each small cavity. During pressing, the waterproof layer within each accommodating portion only needs to fill the small space in which it is located, contributing to a short flow path, low resistance, and uniform pressure transmission, thereby easily allowing the air within the cavity to be completely exhausted through a preset exhaust path. This fundamentally eliminates the problems of distal bubbles and insufficient adhesive caused by an excessively long flow distance. For each accommodating portion divided by the second isolation section, during pressing, the waterproof layer 23 can quickly establish a uniform and controllable internal pressure within the small and relatively regular space. This ensures that, regardless of the shape of the accommodating portion, the waterproof layer inside can cure and form under nearly identical pressure conditions.

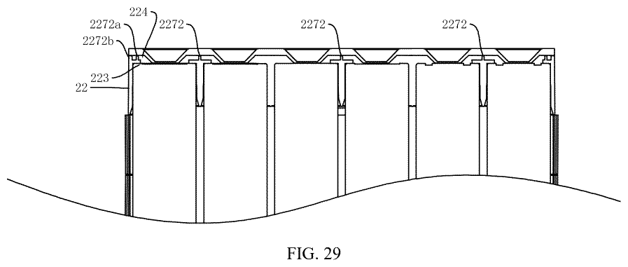

In some implementation manners, the isolation rib 227 may be provided in a single one or a plurality. When the isolation rib 227 includes a single second isolation section 2272, the single second isolation section 2272 can be disposed near the contour edge of the second end 224 to isolate the area inside the contour of the first end face 241 as the accommodating area 2275. When the second isolation section 2272 is provided in a plurality, the plurality of second isolation sections 2272 can be two in number. For example, the second isolation section 2272 includes a first isolation rib 2272a and a second isolation rib 2272b. As shown in FIG. 29, the second isolation rib 2272a and the first isolation rib 2272b are spaced apart to further enhance the isolation effect and form multiple isolation barriers. This can more effectively block or separate adjacent structural members, media, or areas, reducing mutual interference or influence.

The accommodating area 2275 divided by the second isolation section 2272 isolates and protects the unit battery cells 21 located within the accommodating area 2275. Should thermal runaway occur in any battery cell within this accommodating area 2275, its energy will be confined inside the accommodating area 2275. The isolation ribs 227 ensure that the disaster does not spread to adjacent battery cells, meaning each unit battery cell 21 receives protection from the corresponding isolation rib 227. Simultaneously, in the battery pack, thermal runaway in one battery cell can ignite neighboring battery cells through heat conduction and radiation, and the short circuiting of the battery cell can also trigger electrical faults, further exacerbating heat generation and creating a vicious cycle. This design physically cuts off the heat conduction path through physical isolation, thereby breaking this chain reaction. Even if one accommodating area 2275 completely fails due to damage to the isolation rib 227, other accommodating areas 2275 can still maintain electrical and structural independence and safety.

Furthermore, the accommodating area 2275 enclosed by the second isolation section 2272 forms a clearly bounded adhesive containment structure. When the waterproof layer 23 is injected, it is confined within this space and cannot flow freely. When the waterproof member 24 is pressed downward, the waterproof layer 23 within the accommodating area 2275 is compressed. The pressure forces the highly fluid waterproof layer 23 to actively fill every microscopic corner, including the gaps between the battery cell end face and the sidewall of the holder. This pressure-filling method can effectively expel air from the gaps, physically eliminating the conditions for the formation of sealing voids.

Referring to FIG. 23, in another implementation manner, the isolation rib 227 is provided with a plurality of second isolation section 2272, and the plurality of second isolation sections 2272 divide the accommodating area 2275 into at least two accommodating portions; the unit battery cells 21 within the accommodating portions are in an electrically connected state; and the first battery cell end face 211 of at least one of the unit battery cells 21 and the second battery cell end face 212 of another one of the unit battery cells 21 are exposed to the same accommodating portion. The presence of the second isolation sections 2271 divides the originally large single accommodating area 2275 into multiple smaller and mutually independent accommodating portions, achieving an unprecedented level of refined control over the flow behavior of the waterproof layer 23.

The second isolation section 2272 divides a large area into multiple smaller accommodating portions, exponentially shortening the maximum flow distance of the waterproof layer 23 within each small cavity. During pressing, the waterproof layer 23 within each accommodating portion only needs to fill the small space in which it is located, contributing to a short flow path, low resistance, and uniform pressure transmission, thereby easily allowing the air within the cavity to be completely exhausted through a preset exhaust path. This fundamentally eliminates the problems of distal bubbles and insufficient adhesive caused by an excessively long flow distance.

For each accommodating portion divided by the second isolation section 2272, during pressing, the waterproof layer 23 can quickly establish a uniform and controllable internal pressure within the small and relatively regular space. This ensures that, regardless of the shape of the accommodating portion, the waterproof layer 23 inside can cure and form under nearly identical pressure conditions. The entire sealing area is composed of countless second isolation sections 2272 of highly uniform quality assembled together, and the overall consistency and reliability of its performance far exceed that of a large-area sealing layer formed integrally with non-uniform quality.

During the filling of the waterproof layer 23, the second isolation sections 2272 ensure sealing quality; during pressure relief, these second isolation sections 2272, firmly bonded by the waterproof layer 23, become components that enhance the structural strength of the accommodating area 2275 and prevent its premature rupture. Bonded together by the waterproof layer 23, they collectively form a composite assembly that is both tightly sealed and capable of pressure relief on demand.

Referring to FIG. 23, in some implementation manners, the isolation rib 227 is provided with a positioning groove 2276 configured to be recessed from the first isolation section 2271 toward the battery cell end face, and a recess depth of the positioning groove 2276 is 0.5-1.5 mm, for example, 0.5 mm, 0.55 mm, 0.6 mm, 0.65 mm, 0.7 mm, 0.75 mm, 0.8 mm, 0.85 mm, 0.9 mm, 0.95 mm, 1.0 mm, 1.1 mm, 1.2 mm, 1.3 mm, 1.4 mm, or 1.5 mm. The positioning groove 2276 is used for positioning a tab connected to the unit battery cell 21 and provides a physical positioning reference. Operators or automated equipment only needs to place the tab into the positioning groove 2276, and the position of the tab is uniquely determined, eliminating errors from manual measurement and positioning. Every tab is constrained by the same positioning groove 2276, ensuring highly consistent quality across thousands of connection points. This is crucial for guaranteeing uniform internal resistance and voltage distribution across the battery pack.

Furthermore, referring to FIG. 23, the isolation rib 227 further includes a third isolation section 2273 disposed between the first isolation section 2271 and the second isolation section 2272 and extending in a direction perpendicular to the extension direction of the battery cell, and a fourth isolation section 2274 disposed between the first isolation section 2271 and the second isolation section 2272 and extending in a direction opposite to the third isolation section 2273 along the direction perpendicular to the extension direction Z of the battery cell. In this arrangement, between two adjacent isolation ribs 227, a portion between the third isolation section 2273 of one isolation rib 227 and the fourth isolation section 2274 of the other isolation rib 227 forms the exposed hole 222.

Referring to FIG. 24, in some implementation manners, a first thickness L3 of the battery cell holder 22, which is parallel to the first battery cell end face 211 and/or the second battery cell end face 212 of the unit battery cell 21 and within a projection range of the battery cell end face, is less than 5 mm, for example, 1 mm, 2 mm, 3 mm, 3.5 mm, 3.8 mm, 4 mm, 4.2 mm, 4.5 mm, 4.7 mm, or 4.9 mm.

In some implementation manners, the tool battery pack further includes a pressure relief cover disposed inside the housing assembly 1, and the waterproof member 24 is disposed between the pressure relief cover and the battery cell holder 22. The pressure relief cover is at least partially made of a metal material.

The pressure relief cover being at least partially made of a metal material may include: a portion of the pressure relief cover is made of a metal material, or the entire pressure relief cover is made of a metal. If the entire pressure relief cover is made of a metal, it is fully made of a metal with strong heat dissipation capability, which is beneficial for heat dissipation.

In some cases, by configuring a portion of the pressure relief cover to be made of a metal material, the structural strength can be effectively enhanced compared to an all-plastic pressure relief cover. Even if an array of light-transmitting holes is provided in the transparent area, the grid-like structure of the metal substrate can still maintain relatively high rigidity, ensuring long-term alignment accuracy between the light-transmitting holes and the transparent portion of the waterproof member, and reducing detection field misalignment caused by structural deformation. Furthermore, the high-temperature resistance of the metal material can withstand the high-temperature airflow during battery cell pressure relief, reducing risks such as light-transmitting hole blockage or structural collapse in plastic pressure relief covers due to high-temperature softening, thereby ensuring the long-term patency of the pressure relief channel. Simultaneously, the thermal conductivity of metals is higher than that of plastics, allowing for rapid conduction of internal heat from the battery pack. Combined with the air convection effect of the light-transmitting holes, this effectively improves heat dissipation efficiency.

For example, the pressure relief cover may be entirely formed by metal plate stamping, or metal reinforcement rings may be arranged in certain areas. Also for example, the pressure relief cover may have a built-in metal plate, or it may be designed to include a transparent area and a non-transparent area, where at least part of the material in the non-transparent area is a metal material. Certainly, it can also be designed that the transparent area has a plurality of light-transmitting holes arranged in an array to form the transparent area. In this case, at least part of the material in the transparent area may also be designed as a metal material.

In some implementation manners, the unit battery cell has a first battery cell end face and a second battery cell end face, with the first battery cell end face being a positive end face. The pressure relief cover covers the outer contour range collectively defined by all the first battery cell end faces on the battery cell holder. Thus, by explicitly defining the first battery cell end face as the positive end face and configuring the pressure relief cover to cover the outer contour range collectively defined by all the first battery cell end faces on the battery cell holder, on the one hand, all positive end faces are within the protective area of the pressure relief cover. When a unit battery cell experiences abnormal pressure relief or jetting, high-temperature gases and ejected materials are blocked and guided by the pressure relief cover, reducing direct impact on the battery pack housing or adjacent elements, lowering the risk of thermal runaway propagation and escaping electric sparks, thereby improving the operational safety of the battery pack. On the other hand, the pressure relief cover matches the outer contours of all first battery cell end faces, facilitating a unified shielding and sealing design while accounting for machining and assembly tolerances. This simplifies component shapes and assembly processes, enhances the overall structural strength and reliability of the battery cell assembly, and helps prevent external debris, dust, or moisture from entering the positive end face area, extending the service life of the battery cell assembly.

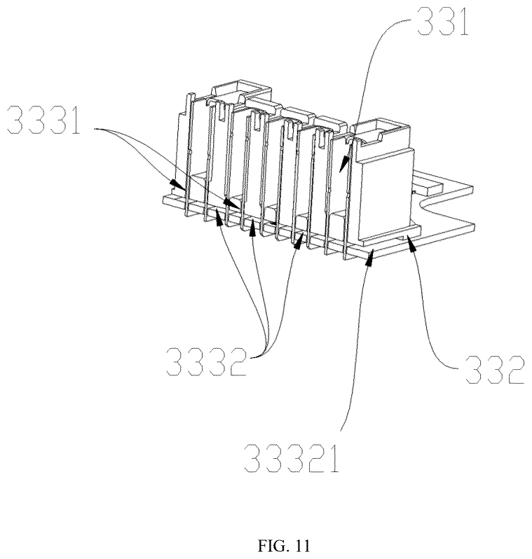

According to an aspect of the present disclosure, a tool battery pack is provided, as shown in FIGS. 11 to 16, including: a housing assembly 1, a battery cell assembly 2, an electrode holder 3, and a control device 4.

In some embodiments, the control device 4 includes a control board and a connecting member, where the connecting member includes: a unit battery cell detector having a first connecting end and a second connecting end, and a connecting tab connected to the unit battery cell through the exposed hole; the first connecting end is connected to the connecting tab, and the second connecting end is connected to the control board.

In some implementation manners, the second connecting end includes at least an equal number of first bonding pads corresponding to the number of the unit battery cells, and the control board includes at least an equal number of second bonding pads corresponding to the number of the first bonding pads, where an area of the first bonding pad is less than or equal to an area of the second bonding pad.

In some implementation manners, the number of the first bonding pads on the second connecting end corresponds to the number of the unit battery cells, and the number of the second bonding pads on the control board corresponds to the number of the first bonding pads, thereby enabling a one-to-one signal transmission link among each unit battery cell, the corresponding first bonding pad and second bonding pad, and the control board. Status data (e.g., voltage, temperature, current, etc.) of each unit battery cell can be collected separately and independently transmitted to the control board via a dedicated bonding pad. This reduces signal interference and crosstalk caused by multiple battery cells sharing a bonding pad, ensuring accurate and error-free parameter collection (voltage, temperature, etc.) for each battery cell, and reducing the risk of missed fault detection due to abnormal signals from a specific battery cell being masked by overall signals. Consequently, the accuracy of battery cell status monitoring is enhanced. Furthermore, this segmented connection structure facilitates individual component replacement and maintenance. If the connecting tab wears out or corrodes due to long-term use, only the connecting tab needs to be replaced, without having to replace the entire unit battery cell detector. If the detector fails, it can also be independently disassembled and replaced, reducing maintenance costs and component waste.

Simultaneously, the independent arrangement of the connecting tab allows it to adapt to unit battery cells of different sizes. By adjusting the configuration of the connecting tab, the connection requirements for different battery cells can be met, improving the versatility of the connecting member.

In some embodiments, the connecting tab is stably connected to the first connecting end of the unit battery cell detector, allowing the collected battery cell signal to be efficiently transmitted to the detector. The signal is then accurately transmitted through the second connecting end of the detector to the control board, forming a complete signal link among the battery cell, the connecting tab, the detector, and the control board, ensuring the stability and timeliness of signal transmission. Furthermore, the arrangement of the connecting tab within the exposed hole does not occupy excessive pressure relief space, reserving sufficient channels for the release of abnormal pressure from the unit battery cell and reducing obstruction to the pressure relief airflow.

The housing assembly 1 includes a holder mounting base (not shown) and an opening 13, and is configured to accommodate the battery cell assembly 2, the electrode holder 3, and the control device 4; the opening 13 is arranged on the housing assembly 1 corresponding to the electrode holder 3 to allow an electrode to pass through and connect with the electrode holder 3; and the holder mounting base (not shown) is arranged on at least one interior side of the housing assembly 1 to secure the battery cell assembly 2.

The battery cell assembly 2 includes at least one cylindrical unit battery cell 21, a battery cell holder 22, and a waterproof member 24, where the battery cell holder 22 is firmly fixed to the holder mounting base in the housing assembly 1 by means of, but not limited to, welding or screw connection to provide additional structural support and anti-vibration protection; the battery cell holder 22 is provided with a receiving slot 221 for the unit battery cell 21 to extend into, with a first end 2211 of the receiving slot 221 having an opening for receiving the unit battery cell 21 and a second end 2212 thereof having the exposed hole 222 penetrating through the battery cell holder 22; an inner area of the exposed hole 222 is smaller than a cross-sectional area of the receiving slot 221 parallel to the exposed hole 222; and an area of the exposed hole 222 is smaller than a maximum area of the first battery cell end face 211 extending into the receiving slot 221.

The waterproof member 24 is arranged at the second end 224 of the battery cell holder 22, has a first end face 241 away from the battery cell holder 22 and a second end face 242 close to the battery cell holder 22, and is provided with a first convex face 2411 at a position of the exposed hole 222.

Referring to FIGS. 10 to 12, the electrode holder 3 is provided with a terminal assembly 32 and a terminal mounting base 33 that includes a guide slot 331, a fixed end 332, and a waterproof space 333, where the guide slot 331 is configured to direct correct insertion of an electrode, reducing installation errors that could lead to short circuiting, while also securing the electrode to ensure effective connectivity with the control device 4; the fixed end 332 is configured to be fixedly connected to the control device 4; and the waterproof space 333 includes a first waterproof space 3331 and a second waterproof space 3332, where the first waterproof space 3331 is an assembly gap between the terminal mounting base 33 and the terminal assembly 32 when the terminal mounting base 33 positions the terminal assembly 32, the second waterproof space 3332 is an assembly gap between the terminal mounting base 33 and the control device 4 and has at least one entry port 33321 located between the terminal mounting base 33 and the control device 4, and the entry port 33321 is designed to facilitate the rapid and uniform penetration of the waterproof material during operation to fill the second waterproof space 3332, thereby enabling efficient waterproofing during installation and maintenance and guaranteeing long-term safe operation of the control device. The fully filled second waterproof space 3332 provides a fundamental waterproof barrier for the terminal assembly 32, protecting internal structures from moisture and contaminants that could otherwise lead to control board malfunctions.

The control device 4 is connected to the electrode holder 3 and is capable of collecting output current and voltage data in real time, adjusting the power supply strategy based on the dynamic load of the tool. For example, when the tool load increases, the control device is capable of quickly raising the output power; when the load decreases, it automatically reduces power consumption, extending the operating time of the battery pack. This adapts to the compatibility requirements of different power tools, enhancing product versatility.

In some implementation manners, the fixed end 332 is a columnar structure with a height that is more than or equal to 0.5 mm and less than or equal to 3 mm, and the fixed end 332 has a first end connected to the terminal mounting base 33 and a second end connected to the control device 4, supporting the terminal mounting base 33 to prevent it from contact with the control device 4; and the second waterproof space 3332 is a projection area of the terminal mounting base 33 on the control device 4, forming a non-contact space between the terminal mounting base 33 and the control device 4.

In some implementation manners, the terminal mounting base 33 is provided with a protruding fixed end 332 on the side adjacent to the control device 4, where the fixed end 332 is connected to the control device 4, supporting the terminal mounting base 33 to prevent it from contact with the control device 4; and the second waterproof space 3332 is a projection area of the terminal mounting base 33 on the control device 4, forming a non-contact space between the terminal mounting base 33 and the control device 4.

In some implementation manners, the waterproof material in both the first waterproof space 3331 and the second waterproof space 3332 is encapsulated in a single molding process via vacuum deposition, where a height of the entry port 33321 is more than or equal to 0.5 mm, and/or a minimum height of the second waterproof space 3332 is more than or equal to 0.5 mm. The height setting of more than or equal to 0.5 mm ensures that, during both the vacuum deposition process and the overall battery pack compression, the waterproof material may fully and uniformly fill the second waterproof space 3332 in a better manner, thereby reducing insufficient filling in central areas of the second waterproof space 3332 and uneven distribution of the waterproof material within the second waterproof space 3332.

In some implementation manners, the waterproof material in both the first waterproof space 3331 and the second waterproof space 3332 is encapsulated in a single molding process via low-pressure injection molding, where a height of the entry port 33321 is more than or equal to 0.8 mm, and/or a minimum height of the second waterproof space 3332 is more than or equal to 0.8 mm. The height setting of more than or equal to 0.8 mm ensures that, during both the low-pressure injection molding process and the overall battery pack compression, the waterproof material may fully and uniformly fill the second waterproof space 3332 in a better manner, thereby reducing insufficient filling in central areas of the second waterproof space 3332 and uneven distribution of the waterproof material within the second waterproof space 3332.

In some implementation manners, the waterproof material in both the first waterproof space 3331 and the second waterproof space 3332 is encapsulated via potting, where a height of the entry port 33321 is more than or equal to 0.5 mm, and/or a minimum height of the second waterproof space 3332 is more than or equal to 0.5 mm. The height setting of more than or equal to 0.5 mm ensures that, during both the potting process and the overall battery pack compression, the waterproof material may fully and uniformly fill the second waterproof space 3332 in a better manner, thereby reducing insufficient filling in central areas of the second waterproof space 3332 and uneven distribution of the waterproof material within the second waterproof space 3332.

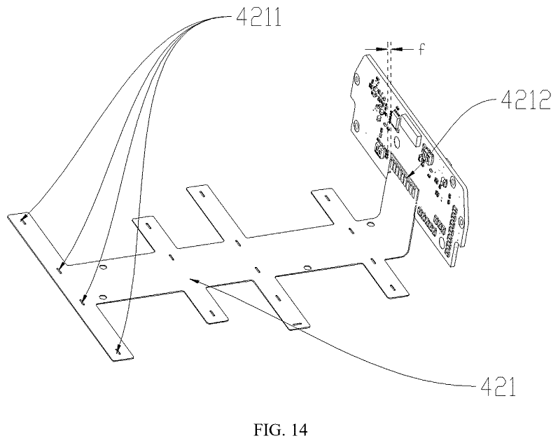

The control device 4 is arranged on the battery cell holder 22 and includes a control board 41 and a connecting member 42, where the control board 41 at least includes a control module and a communication module, and is connected to the unit battery cell 21 via the connecting member 42 through the exposed hole 222 to enable communication and control functions; the control module is configured to regulate parameters such as voltage, current, and temperature within the battery pack to ensure safe and efficient system operation; and the communication module is configured to conduct data exchange with external devices to achieve monitoring of the battery pack's operating status. Referring to FIGS. 14 to 16, the connecting member 42 includes a unit battery cell detector 421 and a connecting tab 422, where the unit battery cell detector 421 has a first connecting end 4211 and a second connecting end 4212; the first connecting end 4211 is connected to the connecting tab 422; the connecting tab 422 is connected to the unit battery cell 21 through the exposed hole 222; and the second connecting end 4212 is connected to the control board 41 through a welding process, thereby preventing poor waterproof performance of terminals in the case of messy power wiring to the control board through the terminals and facilitating easier maintenance of the battery pack. Moreover, status data of each unit battery cell may be independently transmitted to the control board via a dedicated bonding pad. This reduces signal interference and crosstalk caused by multiple battery cells sharing a bonding pad, ensuring accurate and error-free parameter collection (voltage, temperature, etc.) for each battery cell, and effectively detecting abnormalities in the unit battery cells. Consequently, the accuracy and reliability of battery cell status monitoring is further enhanced.

In some implementation manners, the second connecting end 4212 includes at least an equal number of first bonding pads 42121 corresponding to the number of the unit battery cells 21, and the control board 41 includes at least an equal number of second bonding pads 411 corresponding to the number of the first bonding pads 42121 of the second connecting end 4212, where an area of the first bonding pad 42121 is less than or equal to an area of the second bonding pad 411, which ensures the smaller first bonding pad 42121 may be completely attached to the larger second bonding pad 411, effectively reducing potential short-circuit risks between adjacent bonding pads, thereby enhancing circuit safety and reliability, and providing good thermal conduction and electrical connection; meanwhile, the thermal expansion effect of the smaller bonding pad on the larger one helps mitigate mechanical stress caused by thermal expansion and contraction, consequently reducing solder joint fatigue and potential weld cracks, while increasing mechanical strength of the welds and improving connection stability and durability.

In some implementation manners, the second connecting end 4212 includes at least an equal number of first bonding pads 42121 corresponding to the number of the unit battery cells 21, and the control board 41 includes at least an equal number of second bonding pads 411 corresponding to the number of the first bonding pads 42121 of the second connecting end 4212, where the first bonding pad 42121 is provided with at least one through-hole 42122 penetrating the first bonding pad 42121, with a ratio of a diameter of the through-hole 42122 to a width of the first bonding pad 42121 being less than or equal to 1:2, which enhances solder permeability during the welding process and improves both mechanical strength and robustness of electrical connections; and the through-hole enables superior solder filling, resulting in more robust connections with better electrical conductivity.

In some implementation manners, the second connecting end 4212 includes at least an equal number of first bonding pads 42121 corresponding to the number of the unit battery cells 21, and the control board 41 includes at least an equal number of second bonding pads 411 corresponding to the number of the first bonding pads 42121 of the second connecting end 4212, where a minimum distance e between adjacent bonding pads among the first bonding pads 42121 and/or the second bonding pads 411 is more than or equal to 0.2 mm and less than or equal to 2 mm, which effectively reduces short-circuit risks caused by solder bridging or conductive particle contamination while reducing welding defects from manufacturing variations; and the increased distance provides greater tolerance for welding and subsequent operations during manufacturing and handling, enhances overall circuit safety and reliability, prevents signal crosstalk, and improves signal integrity and transmission efficiency, thereby enabling effective heat dissipation for each bonding pad to reduce local overheating due to excessive heat concentration, while facilitating superior thermal diffusion and management.

In some embodiments, the area of the first bonding pad 42121 is less than or equal to the area of the second bonding pad 411. This not only ensures sufficient contact between the first bonding pad and the second bonding pad, reducing misalignment caused by an overly large area of the first bonding pad, or insufficient contact area due to an overly small area, thereby guaranteeing the formation of a stable electrical connection after soldering, reducing contact resistance, and minimizing joule heat generation, but also provides tolerance space for the soldering operation. Even if there is a slight alignment deviation between the first bonding pad and the second bonding pad, the larger second bonding pad may still cover the first bonding pad, reducing issues such as cold solder joints and false soldering, thereby improving the soldering yield. Furthermore, the one-to-one bonding pad design facilitates troubleshooting and maintenance. When signal transmission for a particular unit battery cell is abnormal, the fault point is capable of being quickly located through the corresponding bonding pad (e.g., desoldering, corrosion) without the need to inspect all connecting lines one by one, shortening troubleshooting time. Additionally, the adapted bonding pad area design makes the welding process easier to control, reduces the technical skill requirements for operators, and enhances mass production efficiency.

In some implementation manners, the second connecting end 4212 includes at least an equal number of first bonding pads 42121 corresponding to the number of the unit battery cells 21, and the control board 41 includes at least an equal number of second bonding pads 411 corresponding to the number of the first bonding pads 42121, where a distance f between a surrounding component and an adjacent first bonding pad 42121 and/or second bonding pad 411 is more than or equal to 1 mm and less than or equal to 25 mm. The increased distance f of more than or equal to 1 mm and less than or equal to 25 mm between the bonding pad and the surrounding component helps mitigate electromagnetic interference effects, and this physical isolation is capable of reducing signal coupling on the circuit board, enhance signal integrity, and ensure more stable electrical performance; meanwhile, the greater distance between the surrounding component and the bonding pad reduces short-circuit risks from accidental contact or material bridging (such as solder overflow), providing additional safety margin during production and subsequent equipment operations. Furthermore, the increased distance improves the circuit board's heat dissipation capability, allowing more efficient thermal conduction from high-temperature areas and preventing local overheating and heat accumulation issues.

In some implementation manners, a tin-plating thickness on the first bonding pads 42121 and/or the second bonding pads 411 is 0.05-0.15 mm. By controlling the tin-plating thickness to 0.05-0.15 mm, it is capable of reducing excessive solder flow during the welding process, thereby reducing the risks of solder bridging and short circuiting while simultaneously enhancing electrical isolation in the soldered areas.

In some implementation manners, a tin-plating thickness on the first bonding pads 42121 and/or the second bonding pads 411 is 0.05-0.1 mm.

According to an aspect of the present disclosure, a tool battery pack is provided, including: a housing assembly 1 and a battery cell assembly 2.

The housing assembly 1 includes a holder mounting base (not shown) and an opening 13, and is configured to accommodate the battery cell assembly 2; the opening 13 is arranged on the housing assembly 1 corresponding to an electrode holder 3 to allow an electrode to pass through and connect with the electrode holder 3; and the holder mounting base (not shown) is arranged on at least one interior side of the housing assembly 1 to secure the battery cell assembly 2.

The battery cell assembly 2 includes at least one cylindrical unit battery cell 21, a battery cell holder 22, and a waterproof member 24, where the battery cell holder 22 is firmly fixed to the holder mounting base in the housing assembly 1 by means of, but not limited to, welding or screw connection to provide additional structural support and anti-vibration protection; the battery cell holder 22 is provided with a receiving slot 221 for receiving the unit battery cell 21, with a first end 2211 of the receiving slot 221 having an opening for receiving the unit battery cell 21 and a second end 2212 thereof having the exposed hole 222 penetrating through the battery cell holder 22; an inner area of the exposed hole 222 is smaller than a cross-sectional area of the receiving slot 221 parallel to the exposed hole 222; and an area of the exposed hole 222 is smaller than a maximum area of the first battery cell end face 211 extending into the receiving slot 221.

The waterproof member 24 is arranged at the second end 224 of the battery cell holder 22, has a first end face 241 away from the battery cell holder 22 and a second end face 242 close to the battery cell holder 22, and is provided with a directional pressure relief channel at a position of the exposed hole 222. The waterproof member 24 includes a main body portion 243, and a first connecting portion 244 and a second connecting portion 245 respectively connected to the main body portion 243; a first opening 248 is formed at an intersection of a first face of the main body portion 243 and a first face of the first connecting portion 244; a second opening 249 is formed at an intersection of the first face of the first connecting portion 244 and a first face of the second connecting portion 245; and a directional pressure relief channel is formed along a direction from the first opening 248 toward the second opening 249. The directional pressure relief channel extends toward the unit battery cell 21 to press against a waterproof layer 23 at the exposed hole 222. In the present disclosure, the projection range of the exposed hole 222 refers to a closed area obtained by projecting the exposed hole 222 onto either end face of the waterproof member 24 along an extension direction of a connecting line between the first end face 241 and the second end face 242. The directional pressure relief channel 2412 collectively refers to a pre-set weak section/guide section/easy-tear texture within the closed area and a pressure relief path formed together with a surrounding flow guide portion to open preferentially under abnormal high pressure/high temperature and guide gases and flames in a predetermined direction. The directional pressure relief channel 2412 is used to provide a controllable and predictable pressure relief opening and discharge direction when the unit battery cell 21 overheats and vents, so as to reduce impact on adjacent unit battery cells 21 or adjacent battery cell assemblies 2 and lower the risk of continuous deflagration.

Thus, by integrating the pressure relief channel 2412 with a transparent window, a hidden internal safety mechanism is transformed into an external and directly perceivable safety status indicator. The directional pressure relief channel 2412 is not a simple weak point but a precisely designed channel with specific geometry and opening orientation. It is located within an orthogonal projection area of the exposed hole onto the waterproof member, meaning it is precisely aligned with the internal pressure source (the battery cell).

The directional pressure relief channel 2412 is capable of defining the airflow discharge direction. When the unit battery cell is in a state of thermal runaway, the directional pressure relief channel 2412 is impacted first, ruptures upon impact, and rapidly relieves pressure from the internal space of the battery cell holder, reducing the effect of thermal diffusion. This significantly suppresses the risk of energy generated by thermal runaway spreading to adjacent unit battery cells or other areas of the battery pack (thermal propagation), establishes a safe pressure relief mechanism for the tool battery pack, and substantially enhances the overall safety performance of the tool battery pack. A transparent portion of the waterproof member 24 is arranged relative to the exposed hole, allowing operators to, without disassembling the structure, clearly observe through the transparent portion: whether the exposed hole is completely covered by the waterproof layer, whether there are bubbles/wrinkles in the waterproof layer within the channel, and whether the rupture pattern of the waterproof layer after pressure relief meets the design expectations.

In some implementation manners, the directional pressure relief channel 2412 may be disposed on the first connecting portion 244, or on an integral part enclosed by the first connecting portion 244 and the second connecting portion 245, serving as a weak area of that integral part. Alternatively, the directional pressure relief channel 2412 may be disposed on the second connecting portion 245. When disposed on the second connecting portion 245, the directional pressure relief channel may be the first convex face 2411. In addition, the diameter of the unit battery cell 21 may be designed to be greater than the maximum aperture of the exposed hole 222; and the maximum aperture of the exposed hole 222 may be greater than the diameter of the second opening 249.

In an exemplary implementation manner of the present disclosure, a plurality of directional pressure relief channels or first convex faces 2411 are arranged. Correspondingly, a plurality of exposed holes 222 and unit battery cells 21 are also arranged. Each unit battery cell 21, exposed hole 222, and first convex face 2411/directional pressure relief channel correspond one-to-one.

In some implementation manners, the directional pressure relief channel 2412 in the waterproof member 24 is arranged correspondingly on the first connecting portion, the second connecting portion, or the integral part enclosed by both, forming a weak area. This not only preserves the sealing and waterproofing functions of the main body portion and the first/second connecting portions for the battery cell holder and the unit battery cell but also guides pressure to act preferentially on the preset weak area when the internal pressure of the battery pack rises, causing the directional pressure relief channel to open, thereby achieving directional and controllable pressure relief, and reducing overall damage or sealing failure of the waterproof member caused by disordered pressure impact. Simultaneously, it eliminates the need for additional independent pressure relief structures, simplifying the internal layout of the battery pack while ensuring pressure relief safety, and adapting to the dual requirements of sealing and safety for the tool battery pack.

When the internal pressure of the battery pack reaches a threshold, energy is instantly concentrated at this weakest point, causing it to fracture directly. This reduces the risk of the entire waterproof member undergoing extension, creep, or irregular tearing under enormous pressure, which could lead to pressure relief delays. Since the failure is highly localized, the required energy is minimal, and the response time may reach the millisecond level. Instantaneous response is capable of keeping the internal peak pressure at the lowest possible level, which is crucial for preventing chain reactions and structural explosions.

In some implementation manners, the weak area may be designed into various precise geometric shapes, such as a “cross” shape, a “dash” shape, a circular shape, or a shape with specific flanges. When the weak area ruptures, it opens strictly along the preset geometric path. For example, a “cross”-shaped score line will form a four-petal opening with a calculable and predictable effective flow area. This is fundamentally different from irregular openings formed randomly and partially blocked in ordinary membranes.

In some implementation manners, the main body portion is more robust relative to the first/second connecting portions, significantly enhancing the tolerance of the entire waterproof member 24 under normal operating conditions such as assembly, vibration, and impact. Simultaneously, the presence of the weak area acts like a safety valve, ensuring that under extreme conditions, the system still fails in a preset manner rather than suffering unpredictable damage.

In some implementation manners, the waterproof member 24 extends perpendicular to a first direction and a second direction. That is, the waterproof member 24 may extend along two directions simultaneously. The first direction is perpendicular to the battery cell extension direction, while the second direction is perpendicular to both the battery cell extension direction and the first direction.

The waterproof member 24 has a top end and a bottom end opposite each other in the first direction, the top and/or bottom end has a linear contour, or a notch recessed in the second direction is formed between the top and/or bottom end.

Thus, by employing the continuous linear contour for the oppositely arranged top and/or bottom end of the waterproof member 24 in the first direction, it allows for better adaptation to the linear installation boundaries of components such as the housing assembly and the pressure relief cover. The continuous linear contour may completely fit against the flat surfaces of adjacent components, reducing gaps caused by irregular contours and further blocking moisture infiltration from the edges of the waterproof member. Simultaneously, the linear contour facilitates positioning and assembly. Operators are able to quickly align the relative positions of the waterproof member, the battery cell holder, and the pressure relief cover using the straight edges, ensuring precise correspondence between the first convex face and the exposed hole, and reducing assembly deviations.

In some implementation manners, the waterproof member 24 has a first side end and a second side end opposite each other in the second direction, and a notch recessed in the first direction is formed between the first side end and the second side end. Thus, by arranging the notch recessed in the first direction between the first side end and the second side end of the waterproof member 24, it is capable of reducing the overall weight of the battery pack under the premise of ensuring that the strength of the waterproof member meets usage requirements, enhancing the portability of the tool battery pack.

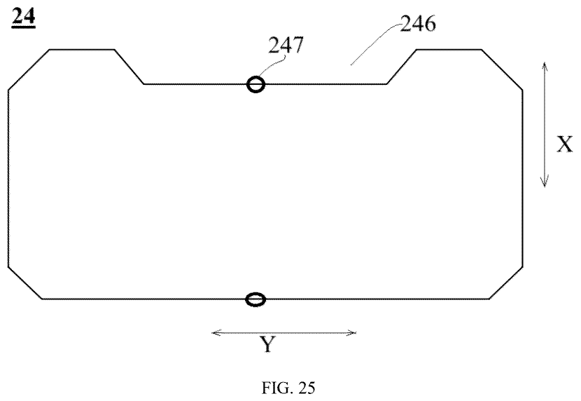

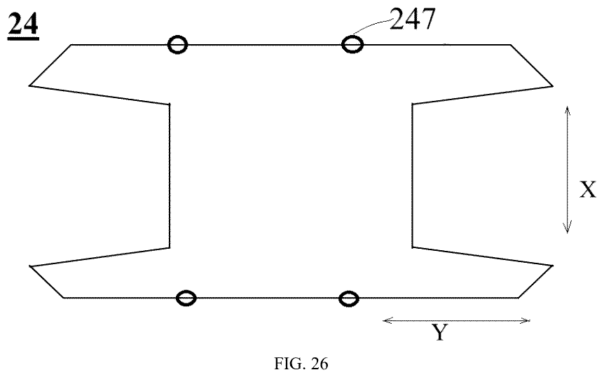

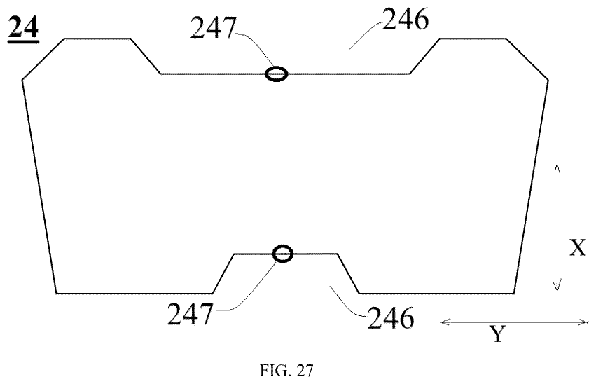

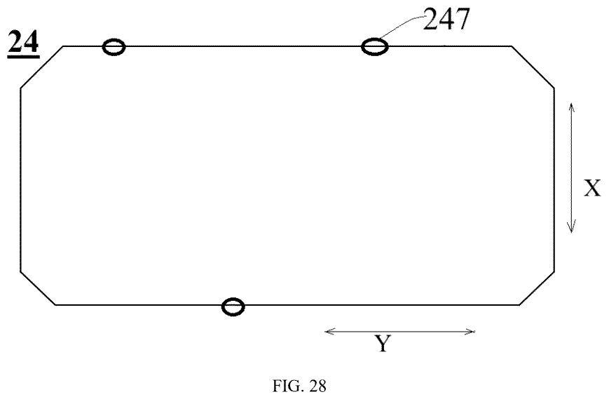

For example, the waterproof member 24 may be any one of the following shapes: concave as shown in FIG. 25, I-shaped as shown in FIG. 26, W-shaped as shown in FIG. 27, or rectangular as shown in FIG. 28. That is to say, the waterproof member 24 has a top end and a bottom end opposite each other in the first direction. Here, as shown in FIGS. 25 to 28, the first direction X may be the height direction of the waterproof member 24 in its normal use state. On this basis, the top end may be designed to have a continuous linear contour. In this case, the bottom end may also be designed to have a continuous linear contour, or the bottom end may have a notch 246 recessed toward the top end in the second direction Y. The second direction is perpendicular to the first direction X. That is to say, the second direction Y may be the width direction of the waterproof member 24 in its normal use state.

By employing a concave, I-shaped, or W-shaped structure, the waterproof member 24 is capable of more precisely adapting to the form of the second end of the battery cell holder and the layout of surrounding components. The concave structure is capable of utilizing the recessed area to accommodate protruding components on the battery cell holder, such as the isolation rib or the positioning groove, reducing structural interference. The upper and lower horizontal portions of the I-shaped structure can closely fit with the pressure relief cover and the battery cell holder, respectively, while the middle vertical portion can reserve a flow channel for pressure relief airflow. The peaks and troughs of the W-shaped structure can adapt to the distribution of exposed holes for multiple groups of unit battery cells, allowing the first convex face to be arranged at positions corresponding to each exposed hole, ensuring consistency in pressure relief for multiple battery cells. Simultaneously, these three shapes can optimize the stress distribution on the waterproof member within a limited space. Compared to a flat-plate waterproof member, they can better distribute assembly pressure and vibration impact, reducing the risk of cracking caused by local stress concentration, and enhancing the structural durability of the waterproof member. Furthermore, the special shape design can also strengthen the synergy between waterproofing and pressure relief functions: the recessed area of the concave shape can form a buffer space with a larger volume together with the first convex face, improving the temporary storage and flow guidance of pressure relief airflow; the vertical portion of the I-shape can guide the directional flow of airflow, reducing disorderly diffusion; the troughs of the W-shape can enhance the sealing fit with the battery cell holder, reducing water infiltration paths. Combined with the sealing effect of the first convex face, this further improves the overall waterproofing performance.

In other implementation manners, the top end can be configured to have a notch 246 recessed toward the bottom end in the second direction Y. In this case, the bottom end may also be designed to have a continuous linear contour, or the bottom end may have a notch 246 recessed toward the top end in the middle of the second direction Y.

When notches are present on both the top and bottom ends, the size of the notch 246 located at the top end and the size of the notch 246 located at the bottom end may be equal or unequal. Those skilled in the art can configure this according to actual conditions, which is not specifically limited herein.

Certainly, it is also possible to design a first side end and a second side end opposite each other in the second direction Y, with a notch 246 recessed in the first direction X between the first side end and the second side end.

On this basis, at least one locking member 247 is arranged at the center of the continuous linear contour; or, at least one locking member 247 is arranged in the notch 246. There may be one or two locking members 247. Here, the continuous linear contour and the notch 246 refer to an individual top end or an individual bottom end. That is to say, when both the top and bottom ends are continuous linear contours, the entire waterproof member 24 includes at least two locking members 247. Thus, the locking member 247 is capable of securely fixing the waterproof member to the battery cell holder or the pressure relief cover, reducing displacement of the waterproof member due to vibration during tool use. This ensures the relative position between the waterproof member and the exposed hole remains unchanged, maintains the patency of the pressure relief channel and the stability of the sealing function, and enhances the installation reliability of the waterproof member.

The method and device provided by the embodiments of the present disclosure have been described in detail above, and specific examples have been used herein to explain the principles and implementation manners of the present disclosure. The descriptions of the above embodiments are only intended to help understand the method and core ideas of the present disclosure. Moreover, in specific implementations, any two of the above embodiments can be arbitrarily combined without conflict. Meanwhile, based on the ideas of the present disclosure, a person of ordinary skill in the art may make modifications in the specific implementation manners and scope of disclosure. In summary, the content of this specification should not be construed as limiting the present disclosure.

What is claimed is:

1. A tool battery pack, comprising:
a battery cell assembly; and
a housing assembly configured to accommodate the battery cell assembly; wherein the battery cell assembly comprises:
a unit battery cell;
a battery cell holder having a first end and a second end, wherein the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and
a waterproof member disposed at the second end of the battery cell holder, wherein the waterproof member has a first end face away from the battery cell holder and a second end face close to the battery cell holder, the waterproof member is provided with a first convex face protruding from the first end face toward the unit battery cell at a position of the exposed hole, and the exposed hole is visible through the waterproof member.

2. The tool battery pack of claim 1, wherein the waterproof member comprises at least one of the following:
the waterproof member is transparent at least within a projection range of the exposed hole;
the waterproof member is made of a first material having a visible light transmittance of 70% or greater;
the waterproof member is made of the first material and the battery cell holder is made of a second material, wherein the first material and the second material have different visual effects; or
the waterproof member is made of the first material and the battery cell holder is made of the second material, wherein the visible light transmittance of the first material is greater than a visible light transmittance of the second material.

3. The tool battery pack of claim 1, wherein the battery cell assembly further comprises a waterproof layer disposed between the waterproof member and the battery cell holder and covering the exposed hole; and
the second end face is a flat surface and is pressed against the waterproof layer.

4. The tool battery pack of claim 1, wherein the battery cell assembly further comprises a waterproof layer disposed between the waterproof member and the battery cell holder and covering the exposed hole; and
the second end face is provided with a second convex face protruding toward the unit battery cell at the exposed hole and is pressed against the waterproof layer at the position of the exposed hole.

5. The tool battery pack of claim 1, wherein
the waterproof member comprises a main body portion, a first connecting portion, and a second connecting portion, wherein the main body portion is connected to the battery cell holder;
the first connecting portion connects the main body portion and the second connecting portion;
the second connecting portion is disposed opposite to the unit battery cell; the waterproof member is provided with a second convex face protruding from the second end face toward the unit battery cell at the exposed hole; and
the main body portion, the first connecting portion, and the second connecting portion each have a first face away from the battery cell holder and a second face close to the battery cell holder;
wherein the first end face at least comprises the first face of the main body portion, the first face of the second connecting portion, and the first face of the first connecting portion with two ends respectively connected to the first face of the main body portion and the first face of the second connecting portion; the second end face at least comprises the second face of the main body portion, the second face of the second connecting portion, and the second face of the first connecting portion with two ends respectively connected to the second face of the main body portion and the second face of the second connecting portion;
the first convex face at least comprises the first face of the first connecting portion and the first face of the second connecting portion connected to the first face of the first connecting portion; the second convex face at least comprises the second face of the first connecting portion and the second face of the second connecting portion connected to the second face of the first connecting portion, and
in a direction of a connecting line between the first end face and the second end face, an offset exists between the first face of the main body portion and the first face of the second connecting portion forming a recessed space of the first convex face.

6. The tool battery pack of claim 5, wherein the tool battery pack comprises at least one of the following:
a vertical distance b1 between the first face and the second face of the main body portion is different from a vertical distance b2 between the first face and the second face of the first connecting portion;
the vertical distance b1 between the first face and the second face of the main body portion is different from a vertical distance b3 between the first face and the second face of the second connecting portion; or
the vertical distance b2 between the first face and the second face of the first connecting portion is different from the vertical distance b3 between the first face and the second face of the second connecting portion.

7. The tool battery pack of claim 6, wherein the tool battery pack comprises at least one of the following:
the vertical distance b1 between the first face and the second face of the main body portion is greater than the vertical distance b2 between the first face and the second face of the first connecting portion;
the vertical distance b1 between the first face and the second face of the main body portion is greater than the vertical distance b3 between the first face and the second face of the second connecting portion;
the vertical distance b2 between the first face and the second face of the first connecting portion is greater than the vertical distance b3 between the first face and the second face of the second connecting portion; or
the vertical distance b2 between the first face and the second face of the first connecting portion is less than the vertical distance b3 between the first face and the second face of the second connecting portion.

8. The tool battery pack of claim 7, wherein the tool battery pack comprises at least one of the following:
the unit battery cell has a battery cell end face facing the waterproof member, the first connecting portion is arranged obliquely with the main body portion as a reference, and an inclination angle B of the first connecting portion relative to the main body portion is 30° to 60°;
the first face of the second connecting portion is provided with a first groove recessed toward the second end face, and an area of the first groove is 30% to 60% of a projected area of the unit battery cell onto the second end face;
the second face of the second connecting portion is provided with a second groove recessed toward the first end face, and an area of the second groove is 30% to 60% of the projected area of the unit battery cell onto the second end face;
an area of the second face of the second connecting portion is 30% to 60% of an end face area of the battery cell end face;
an area of the first face of the second connecting portion is 30% to 60% of the end face area of the battery cell end face;
the area of the second face of the second connecting portion is 40% to 70% of an aperture area of the exposed hole;
the recessed space comprises a first opening formed at an intersection of the first face of the main body portion and the first face of the first connecting portion, and a second opening formed at an intersection of the first face of the first connecting portion and the first face of the second connecting portion, and a projected area of the second opening is 40% to 70% of an area of the first opening; or
the area of the second face of the second connecting portion is 40% to 70% of a projected area of the first opening.

9. The tool battery pack of claim 5, wherein the tool battery pack comprises at least one of the following:
the vertical distance b3 between the first face and the second face of the second connecting portion is 0.3-1.5 mm;
a vertical distance L2 between the second face of the second connecting portion and the battery cell end face is 0.1-2 mm; or
a first thickness L3 of the battery cell holder, which is parallel to the battery cell end face and within a projection range of the battery cell end face, is less than 5 mm.

10. The tool battery pack of claim 1, wherein
the unit battery cell has a first battery cell end face and a second battery cell end face, and the first battery cell end face and the second battery cell end face are battery cell end faces with opposite polarities;
the battery cell holder is provided with an isolation rib that comprises a first isolation section and a second isolation section, wherein the first isolation section is disposed parallel to an extension direction of the unit battery cell between the first battery cell end face and the second battery cell end face, and the second isolation section extends parallel to the extension direction of the unit battery cell and protrudes beyond the first battery cell end face; the second isolation section encloses an accommodating area; and
the unit battery cell is provided in a plurality, and the plurality of unit battery cells are connected to the same battery cell holder; within the accommodating area, the unit battery cells are in an electrically connected state; the first battery cell end face of at least one of the unit battery cells and the second battery cell end face of another one of the unit battery cells are exposed to the accommodating area.

11. The tool battery pack of claim 10, wherein the isolation rib comprises at least one of the following:
the second isolation section of the isolation rib is provided in a plurality, and the plurality of second isolation sections divide the accommodating area into at least two accommodating portions; the unit battery cells within the accommodating portions are in an electrically connected state; and among the unit battery cells, the first battery cell end face of at least one of the unit battery cells and the second battery cell end face of another one of the unit battery cells are exposed to the same accommodating portion; or
the isolation rib is provided with a positioning groove configured to be recessed from the first isolation section toward the battery cell end face for positioning a tab connected to the unit battery cell, and a recess depth of the positioning groove is 0.5-1.5 mm.

12. The tool battery pack of claim 1, wherein the waterproof member extends along a first direction and a second direction respectively; the first direction is perpendicular to a battery cell extension direction; the second direction is perpendicular to both the battery cell extension direction and the first direction; and the waterproof member comprises at least one of the following:
the waterproof member has a top end and a bottom end opposite each other in the first direction, the top and/or bottom end has a linear contour, or a notch recessed in the second direction is formed between the top and/or bottom end; or
the waterproof member has a first side end and a second side end opposite each other in the second direction, and a notch recessed in the first direction is formed between the first side end and the second side end.

13. A tool battery pack, comprising:
a battery cell assembly; and
a housing assembly configured to accommodate the battery cell assembly;
wherein the battery cell assembly comprises:
a unit battery cell;
a battery cell holder having a first end and a second end, wherein the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and
a waterproof member disposed at the second end of the battery cell holder, wherein the waterproof member is provided with a directional pressure relief channel within a projection range of the exposed hole, and the waterproof member is transparent at least within the projection range of the exposed hole.

14. The tool battery pack of claim 13, wherein
the waterproof member comprises a main body portion, a first connecting portion, and a second connecting portion, wherein the first connecting portion connects the main body portion and the second connecting portion, and the second connecting portion is disposed opposite to a battery cell end face of the unit battery cell; and
the directional pressure relief channel is configured to be at least one of the following:
the directional pressure relief channel is disposed on the second connecting portion and forms a weak area of the second connecting portion,
the directional pressure relief channel is disposed on the first connecting portion and forms a weak area of the first connecting portion, or
the directional pressure relief channel is disposed on an integral part enclosed by the first connecting portion and the second connecting portion and serves as a weak area of the integral part.

15. The tool battery pack of claim 14, wherein
the second connecting portion is disposed opposite to the unit battery cell; the waterproof member is provided with a second convex face protruding from the second end face toward the unit battery cell at the exposed hole; and
the main body portion, the first connecting portion, and the second connecting portion each have a first face away from the battery cell holder and a second face close to the battery cell holder;
wherein the first end face at least comprises the first face of the main body portion, the first face of the second connecting portion, and the first face of the first connecting portion with two ends respectively connected to the first face of the main body portion and the first face of the second connecting portion; the second end face at least comprises the second face of the main body portion, the second face of the second connecting portion, and the second face of the first connecting portion with two ends respectively connected to the second face of the main body portion and the second face of the second connecting portion; and
the first convex face at least comprises the first face of the first connecting portion and the first face of the second connecting portion connected to the first face of the first connecting portion; the second convex face at least comprises the second face of the first connecting portion and the second face of the second connecting portion connected to the second face of the first connecting portion; and in a direction of a connecting line between the first end face and the second end face, an offset exists between the first face of the main body portion and the first face of the second connecting portion, forming a recessed space of the first convex face.

16. The tool battery pack of claim 14, wherein the tool battery pack comprises at least one of the following:
the unit battery cell has a battery cell end face facing the waterproof member, the first connecting portion is arranged obliquely with the main body portion as a reference, and an inclination angle B of the first connecting portion relative to the main body portion is 30° to 60°;
the first face of the second connecting portion is provided with a first groove recessed toward the second end face, and an area of the first groove is 30% to 60% of a projected area of the unit battery cell onto the second end face;
the second face of the second connecting portion is provided with a second groove recessed toward the first end face, and an area of the second groove is 30% to 60% of the projected area of the unit battery cell onto the second end face;
an area of the second face of the second connecting portion is 30% to 60% of an end face area of the battery cell end face;
an area of the first face of the second connecting portion is 30% to 60% of the end face area of the battery cell end face;
the area of the second face of the second connecting portion is 40% to 70% of an aperture area of the exposed hole;
the recessed space comprises a first opening formed at an intersection of the first face of the main body portion and the first face of the first connecting portion, and a second opening formed at an intersection of the first face of the first connecting portion and the first face of the second connecting portion, and a projected area of the second opening is 40% to 70% of an area of the first opening;
the area of the second face of the second connecting portion is 40% to 70% of a projected area of the first opening;
a vertical distance b3 between the first face and the second face of the second connecting portion is 0.3-1.5 mm;
a vertical distance L2 between the second face of the second connecting portion and the battery cell end face is 0.1-2 mm; or
a first thickness L3 of the battery cell holder, which is parallel to the battery cell end face and within a projection range of the battery cell end face, is less than 5 mm.

17. The tool battery pack of claim 13, further comprising:
a waterproof layer disposed between the waterproof member and the battery cell holder and covering the exposed hole, wherein the directional pressure relief channel is located within the projection range of the exposed hole, and the directional pressure relief channel extends toward the unit battery cell to press against the waterproof layer at the exposed hole.

18. The tool battery pack of claim 13, wherein
a diameter of the unit battery cell is greater than a maximum aperture of the exposed hole, and the maximum aperture of the exposed hole is greater than a diameter of the second opening.

19. A tool battery pack, comprising:
a battery cell assembly;
a housing assembly configured to accommodate the battery cell assembly; and
a pressure relief cover disposed inside the housing assembly;
wherein the battery cell assembly comprises:
a unit battery cell;
a battery cell holder having a first end and a second end, wherein the first end of the battery cell holder is provided with a receiving slot for accommodating the unit battery cell, one end of the receiving slot has an opening for the unit battery cell to extend into, and the other end of the receiving slot has an exposed hole penetrating through the battery cell holder; and
a waterproof member disposed at the second end of the battery cell holder, wherein the waterproof member is transparent at least within a projection range of the exposed hole, and the waterproof member is disposed between the pressure relief cover and the battery cell holder.

20. The tool battery pack of claim 19, wherein the pressure relief cover is at least partially made of a metal material.
